(19) United States
(12) Patent Application Publication
(10) Pub. No.: US 2026/0299586 A1
(43) Pub. Date: Oct. 1, 2026

(54) MAP-LESS LOCALIZATION AND AUTONOMOUS NAVIGATION OF MOBILE ROBOTS

(71) Applicant: Anram Holdings, Oakville (CA)

(72) Inventors: Debanik ROY, Nadia West, Bengal (IN); Sanjeev KUMAR, Sitamarhi Bihar (IN); Ajay VISHNU, Gurgaon Haryana (IN); Prakash Valentino RAMANAND, Burlington (CA)

(73) Assignee: Anram Holdings, Oakville, ON (CA)

(21) Appl. No.: 19/469,218

(22) PCT Filed: Mar. 23, 2024
(86) PCT No.: PCT/IB2024/052800

§ 371 Date: Sep. 25, 2025

(30) Foreign Application Priority Data
Mar. 25, 2023 (IN) 202311021532

(51) Int. Cl. G05D 1/24; G01S 15/08; G01S 17/86; G01S 17/89; G05D 109/10; G05D 111/10; G05D 111/20

(52) U.S. Cl. CPC G05D 1/24; G01S 15/08; G01S 17/86; G01S 17/89; G05D 2109/10; G05D 2111/17; G05D 2111/20

(57) ABSTRACT

Embodiments of the present application provide systems and methods for map-less localization and autonomous navigation of mobile robots. The system includes a controller in communication with a robot including a camera. The controller may be configured to receive an image including a target object, a camera location on the robot, a camera orientation, and a camera distance to the target object; determine a first target point on the target object with respect to the camera location; define a reference point in the image for providing a world coordinate system, where the reference point includes a center of the image; determine a second target point in the image with respect to the reference point and based on the camera orientation, the camera distance, and the first target point; and localize the robot in the world coordinate system based on the second target point.

### TECHNICAL FIELD

The present application generally relates to systems and methods for autonomous control and navigation of mobile robots. More particularly, the present application relates to systems and methods for a map-less localization and autonomous navigation of mobile robots.

### BACKGROUND

Mobile robots must navigate reliably and safely in real-world environments to carry out various tasks such as cleaning, item delivery, and teleconference. These robots typically rely on a map of an environment for autonomous navigation. The map usually contains static features representing the positions of obstacles fixed with respect to time in the environment. The static features in the map assist in periodically determining a pose (i.e., position and orientation) of a mobile robot in the underlying environment by a process called localization. The mobile robot then implements a path-planning algorithm based on the determined pose to navigate autonomously within the environment. However, creating or preserving an accurate map for localization and autonomous navigation may become time-intensive, sometimes even infeasible, when deploying the mobile robot in a new or unknown real-world environment to amplify area downtime and related operational costs. Moreover, the reliance on a preset map of a dynamic environment (e.g., crowded area, event venues, etc.), where the positions of objects/obstacles change, may cause an autonomous mobile robot to localize and/or navigate inaccurately.

State-of-the-art solutions typically train a navigation model for autonomous navigation to a target location in a simulated environment (e.g., Unity3D environment, Unreal environment, etc.). The trained model is then transferred to a mobile robot for autonomously navigating to the target location in a real-world environment, which is similar to the simulated environment. However, these typical model-based solutions are usually limited to that specific target location and do not provide any guidance for a dynamic generation of new target locations without user input or the corresponding location map. Moreover, training the navigation model in simulation often fails to adapt accurately to motion physics and unknown/dynamic obstacles in the real world at the detriment of computational delay and battery drain, thereby increasing the total time required for performing an intended task.

There is a need for an improved and robust solution for map-less localization and autonomous navigation of mobile robots in real-world environments without amplifying battery usage, computational delay, and area downtime.

### SUMMARY

One embodiment of the present application includes a computer-implemented method for a map-less localization of a robot. The computer-implemented method includes receiving an image from a camera on a robot, where the image includes a target object. The method also includes accessing a camera location on the robot, a camera orientation, and a camera distance to the target object. The method further includes determining a first target point in the image. The first target point may include a portion of the target object, where the first target point is determined with respect to the camera location. Moreover, the method includes defining a reference point in the image for providing a world coordinate system, where the reference point includes a center of the image. The method also includes determining a second target point in the image based on the camera orientation, the camera distance, and the first target point. The second target point may be determined with respect to the reference point, where the second target point includes the portion of the target object. The method further includes localizing the robot in the world coordinate system based on the second target point.

Another embodiment of the present application includes a system for a map-less localization of a robot. The system includes a robot including a camera, and a controller in communication with the robot. The controller may be configured to receive an image from a camera on a robot, where the image includes a target object; access a camera location on the robot, a camera orientation, and a camera distance to the target object; and determine a first target point in the image. The first target point may include a portion of the target object, where the first target point is determined with respect to the camera location. The controller may be further configured to define a reference point in the image for providing a world coordinate system, where the reference point includes a center of the image; and determine a second target point in the image based on the camera orientation, the camera distance, and the first target point. The second target point may be determined with respect to the reference point, where the second target point includes the portion of the target object. The processor may be also configured to localize the robot in the world coordinate system based on the second target point.

The above summary of exemplary embodiments is not intended to describe each disclosed embodiment or every implementation of the present application. Other and further aspects and features of the application would be evident from reading the following detailed description of the embodiments, which are intended to illustrate, not limit, the present application.

### BRIEF DESCRIPTION OF DRAWINGS

The illustrated embodiments of the subject matter will be best understood by reference to the drawings, wherein like parts are designated by like numerals throughout. The following description is intended only by way of example, and simply illustrates certain selected embodiments of devices, apparatuses, systems, and methods that are consistent with the subject matter as claimed herein.

FIG. 1 is a mobile robot including an exemplary map-less localization and navigation (MLN) system, according to an embodiment of the present application.

FIG. 2 is an exemplary map-less localization and navigation (MLN) system for the mobile robot of FIG. 1, according to an embodiment of the present application.

FIG. 3 is an exemplary image frame including a target object for the MLN system of FIG. 1, according to an embodiment of the present application.

FIG. 4 illustrates a set of clusters of data points related to the target object of FIG. 3, according to an embodiment of the present application.

FIG. 5 is a schematic illustrating respective coordinate systems of a camera and a Light Detection and Ranging (LIDAR) sensor for the mobile robot of FIG. 1, according to an embodiment of the present application.

FIG. 6 is a schematic illustrating an exemplary independent reference point in the image frame of FIG. 3, according to an embodiment of the present application.

FIGS. 7-10 are schematics illustrating different exemplary positions of the independent reference point of FIG. 6 with respect to target points associated with the target object of FIG. 3, according to an embodiment of the present application.

FIG. 11 is a schematic illustrating exemplary distances calculated to different surfaces including the target object from a frame of reference of the LIDAR sensor of FIG. 5, according to an embodiment of the present application.

FIG. 12 is a schematic illustrating an exemplary transformation of an ultrasonic frame of reference to a pseudo-LIDAR frame of reference, according to an embodiment of the present application.

FIG. 13 is a schematic illustrating exemplary goal points determined around the target object of FIG. 3, according to an embodiment of the present application.

### DETAILED DESCRIPTION

The following detailed description is provided with reference to the drawings herein. Exemplary embodiments are provided as illustrative examples so as to enable those skilled in the art to practice the disclosure. It will be appreciated that further variations of concepts and embodiments disclosed herein can be contemplated. The examples described in the present application may be used together in different combinations. In the following description, details are set forth in order to provide an understanding of the present application. It will be readily apparent, however, that the present application may be practiced without limitation to all these details in some embodiments. Also, throughout the present application, the terms “a” and “an” are intended to denote at least one of a particular element. The terms “a” and “an” may also denote more than one of a particular element. As used herein, the term “includes” means includes but not limited to, the term “including” means including but not limited to. The term “based on” means based at least in part on, the term “based upon” means based at least in part upon, and the term “such as” means such as but not limited to. The term “relevant” means closely connected or appropriate to what is being done or considered. The term “approximately” or “about” means+/−1%, +/−2%, +/−5%, +/−10%, +/−15%, +/−20% of the stated number or an expected value. The term “substantially” means+/−1%, +/−2%, +/−5%, +/−10%, +/−15%, +/−20%, deviation from an expected value or a target value of an associated parameter.

Further, where certain elements of the present application can be partially or fully implemented using known components, only those portions of such known components that are necessary for an understanding of the present application will be described, and detailed descriptions of other portions of such known components are omitted so as not to obscure the invention(s). In the present application, an embodiment showing a singular component should not be considered limiting; rather, the present application is intended to encompass other embodiments including a plurality of the same component, and vice-versa, unless explicitly stated otherwise herein. Moreover, the applicant does not intend for any term in the present application to be ascribed an uncommon or special meaning unless explicitly set forth as such. The present application also encompasses present and future known equivalents to the components referred to herein.

Embodiments are disclosed in the context of map-less localization and autonomous navigation of a mobile robot to perform an intended task. Examples of the task may include, but are not limited to, disinfection or cleaning, food transfer, item delivery, information display and control, teleconference, simulation, healthcare, environment mapping, path planning, animation, and track/monitor/control/record an action with respect to a target.

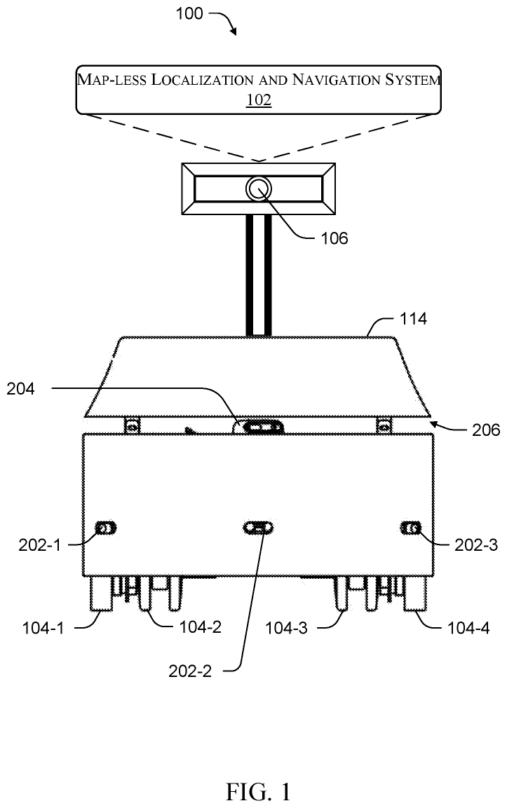

FIG. 1 is a mobile robot 100 including an exemplary map-less localization and navigation (MLN) system 102, according to an embodiment of the present application. The mobile robot 100 may be adapted for any intended applications such as, without limitation, cleaning, decontamination, disinfection, curing, transportation, palletizing, hauling, lifting, elevating, hoisting, and storage. In the present application, the term “cleaning” may refer to cleaning, sweeping, scrubbing, waxing, polishing, wetting, drying, and/or vacuuming a surface. Moreover, in the present application, the term “disinfection” may refer to inactivation or killing of pathogens on a target surface or atmosphere UV light alone or in combination with any other suitable agents such as chemical agents (e.g., alcohols, aldehydes, oxidizing agents, naturally occurring or modified compounds, etc.), physical agents (e.g., heat, pressure, vibration, sound, radiation, plasma, electricity, etc.), and biological agents (e.g., disinfecting micro-organisms, plants or plant products, organic residues, etc.). Further, in the present application, the term “decontamination” may refer to removal or neutralization of unwanted substances from a target surface or enveloping atmosphere. In one example, the mobile robot 100 may include any suitable apparatus (not shown) adapted for intended applications. Examples of the apparatus may include, but are not limited to, a robotic arm, a portable or a handheld unit, and an ultraviolet (UV) unit including a UV source. The robotic arm, in some instances, may be configured to operably receive or control the handheld unit and/or the UV unit. The handheld unit, in some instances, may include the UV source, an airflow source, a reflector, or any combinations thereof. Furthermore, in some examples, the mobile robot 100 may include a machine, or vice versa. In further examples, the mobile robot 100 may include a vehicle, or vice versa. In some instances, the vehicle may be removably coupled to the mobile robot 100.

In one embodiment, the mobile robot 100 may be configured to operate or navigate autonomously; however, some examples may include the mobile robot 100 being also configured to be moved manually or automatically via a remote device. Examples of the remote device may include, but are not limited to, a beacon, a robot, and a computing device. The mobile robot 100 may include various components to assist in spatial navigation. For example, as illustrated in FIG. 1, the mobile robot 100 may include wheels 104-1, 104-2, 104-3, and 104-4 (hereinafter collectively referred to as wheels 104). Further, the mobile robot 100 may include a platform 114 configured to support or carry a payload based on intended applications. Examples of the payloads may include, but are not limited to, a component, a tool, a vehicle, a person(s), a container, and an apparatus such as the ones discussed above. In some examples, the payload may be permanently connected, detachably coupled, removably received, or formed integral to the mobile robot 100.

The mobile robot 100 may be configured to operate in communication with the computing device via a network. Examples of the computing device include, but are not limited to, desktop computers, personal digital assistants, servers, mainframe computers, mobile computing devices (e.g., mobile phones, laptops, standalone or smart remote-control devices, access cards, etc.), and Internet appliances. In some examples, the computing device may be adapted to become fixed or stationary, mobile, portable, handheld, or wearable during communication with the mobile robot 100. Further, the mobile robot 100 may include hardware and installed software, where the hardware is closely matched to the requirements or functionality of the software. Some examples may include the mobile robot 100 being configured with software, firmware, or other resources that support remote administration, operation, and maintenance of the mobile robot 100. In some other examples, the mobile robot 100 may operate, or inhibit operation, in response to a stimulus from a target entity such as an inanimate object or the computing device.

The mobile robot 100 may also include a variety of known, related art, or later developed interface(s), including software interfaces and hardware interfaces. Examples of the software interfaces may include, but are not limited to, an application programming interface and a graphical user interface. Examples of the hardware interfaces may include, but are not limited to, cables, cable connectors, a keyboard, an access card reader, a barcode reader, a scanner, an interactive display screen, a printer, a telemetry circuit, and one or more types of sensors such as temperature sensors, moisture sensors, light sensors, disinfection sensor, odometer, gyroscope, magnetometer, and accelerometers. The interface(s) may facilitate communication between various devices or components operationally connected to or with the mobile robot 100. In some examples, the mobile robot 100 may be configured to include video, voice, or data communication capabilities.

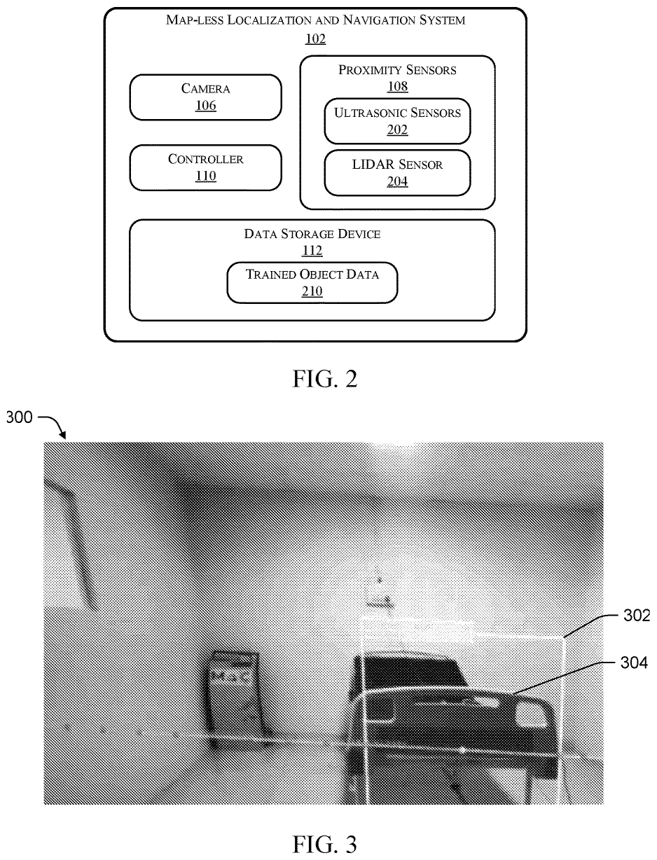

In one embodiment, as illustrated in FIG. 1, the mobile robot 100 may include an MLN system 102, or a controller 110 (shown in FIG. 2), configured to (i) navigate the mobile robot 100 autonomously, (ii) self-localize the mobile robot 100 without any priori/prior information and/or maps of the surrounding environment, (iii) generate new navigation paths and goals for the mobile robot 100 based on a preset task, (iv) transform an obstacle into a target, or vice versa based on a predefined target object category, (v) perform or skip a target-oriented task based on the transformation, (vi) dynamically create or manipulate a navigation pattern with respect to a target, (vii) plan a path (or a sub-path) to a goal based on the navigation pattern, (viii) switch between an autonomous mode and a non-autonomous mode such as automatic mode, manual mode, and remote-controlled mode, or any combinations thereof.

As illustrated in FIG. 2, in one embodiment, the MLN system 102 may include a camera 106, proximity sensors 108, the controller 110, and a data storage device 112. In one example, the camera 106 may be ZED2™ stereo camera; however, any other suitable types of camera known in the art may also be implemented. Further, the MLN system 102 may include the proximity sensors 108 in any suitable configuration to assist in map-less localization and autonomous navigation of the mobile robot 100. The proximity sensors 108 may include a single sensor or a set of the same or different types of sensors. In the present application, references to a sensor may include an independent sensor, a sensor array, a sensor device comprising additional components, a sensor device array, or any combinations thereof.

In one embodiment, the proximity sensors 108 may include ultrasonic sensors 202-1, 202-2, 202-3 (hereinafter collectively referred to as ultrasonic sensors 202). The ultrasonic sensors 202 may be removably secured to the mobile robot 100. In the illustrated example, the ultrasonic sensors 202 may be mounted on to a front side of the mobile robot 100; however, other examples may include similar sensors also mounted to a rear side and one or more lateral sides of the mobile robot 100. The ultrasonic sensors 202 may be mounted along an outer periphery of the mobile robot 100. Each of the ultrasonic sensors 202 have a three-dimensional (3D) field of view extending in a 3D plane (or multiple two-dimensional (2D) planes) up to a preset maximum range, i.e., a first detection range. As shown in FIG. 1, the ultrasonic sensors 202 may be mounted in a lower section of the mobile robot 100 and proximate to the ground to assist in detection of small objects and speed breakers along a path being traversed by the mobile robot 100; however, other suitable positions, including upper and/or lateral portions, on the mobile robot 100 may also be contemplated for mounting the ultrasonic sensors 202.

The proximity sensors 108 may further include a LIDAR sensor 204 mounted with the mobile robot 100. For example, as illustrated in FIG. 1, the LIDAR sensor 204 may be mounted proximate to the ultrasonic sensors 202. In some examples, the LIDAR sensor 204 may be placed at or proximate to a geometrical center (or base link) of the mobile robot 100 or a portion thereof. The LIDAR sensor 204 may be located in a horizontal plane below the camera 106 to assist in determining a proximity to nearby objects located in a set plane above the ultrasonic sensors 202. In one example, the LIDAR sensor 204 may be located at a height ranging from approximately 0.3 meters to approximately 0.8 meters; however, other examples may include at any heights above approximately 0.3 meters depending on relative positions of the camera 106 and the ultrasonic sensors 202. Further, in the illustrated example of FIG. 1, the LIDAR sensor 204 emits optical pulses through a gap 206 in the mobile robot 100. The gap 206 may be located between the platform 114 and the wheels 104. In some examples, the gap 206 may be positioned between the camera 106 and the platform 114. The gap 206 may be transparent to the ambient environment. In some instances, the gap 206 may be enclosed or encased within a transparent housing (not shown) supported by the mobile robot 100. Other examples may include the gap 206 may exclude the LIDAR sensor 204.

In one embodiment, the LIDAR sensor 204 may operate as a two-dimensional (2D) LIDAR sensor 204 having a 2D field of view; however, other examples may include a 3D LIDAR sensor 204, or multiple 2D LIDAR sensors collectively, having a 3D field of view. The 2D field of view may include a 2D plane extending up to a predefined maximum range, i.e., a second detection range, which may be greater than the first detection range. The 2D plane may be substantially parallel to the ground or a horizontal axis of the mobile robot 100; however, some examples may include the 2D plane at a preset angle relative to the horizontal axis. In the illustrated example (FIG. 1), the LIDAR sensor 204 is implemented as a rotational scanner operating to perform a 360-degree scan (also, referred to as an omnidirectional scan) of the environment about the mobile robot 100. The LIDAR sensor 204 may rotate about a vertical axis of the mobile robot 100. The vertical axis, in some examples, may pass through a geometric center, or a center of mass, of the mobile robot 100. Other examples may include the vertical axis passing through a plane comprising a side of the mobile robot 100. The rotating LIDAR sensor 204 may scan the 2D plane including the omnidirectional plane encircling the mobile robot 100 or a portion thereof. In one example, the LIDAR sensor 204 is, or includes, RPLIDAR A1™ sensor having a field of view of 360 degrees in the 2D plane with a sample size of 8000 samples per second and a maximum range of 12 meters; however, other suitable types of LIDAR sensors known in the art, related art, or developed later may also be contemplated depending on an intended functionality and an intended application area of the mobile robot 100.

In some examples, the MLN system 102 may also include a motor (not shown) configured to assist in controlling an autonomous operation of the mobile robot 100. In the present application, references to a motor may include an independent motor, a set of motors including the same or different types of motors, a motor assembly comprising additional components, or any combinations thereof. In one example, the motor may be connected to at least one of the wheels 104. The motor may provide a torque to rotate a connected wheel for spatially moving the mobile robot 100. For example, the motor may drive the connected wheel to move the mobile robot 100 in forward and/or reverse directions; however, some examples may include the motor being configured to additionally move the mobile robot 100 sideways or laterally with or without changing an orientation of the mobile robot 100 depending on a functionality of the connected wheels 104 (e.g., Mecanum wheels). In some examples, the motor may be configured to provide a differential torque to a set of two or more connected wheels for steering the mobile robot 100 during navigation. For instance, the motor may provide the differential torque to steer the mobile robot 100 in different directions by controlling the speed and/or direction of rotation of one or more connected wheels. Other examples may include the motor additionally assisting to rotate the mobile robot 100 about the vertical axis at a set spatial position. The motor, in communication with the camera 106 and the proximity sensors 108, may be controlled by a controller 110.

The controller 110 may correspond to an electronic or an electromechanical component configured to control various components and functions of the mobile robot 100. In some examples, the controller 110 may operate in communication with the remote device to control the mobile robot 100. Other examples may include the controller 110 being configured to control or manipulate a functionality of the remote device. The controller 110 may be implemented by way of a single device (e.g., a computing device, a processor, or an electronic storage device) or a combination of multiple devices. The controller 110 may be implemented in hardware or a suitable combination of hardware and software. The “hardware” may comprise a combination of discrete electronic or electromechanical components, an integrated circuit, an application-specific integrated circuit, a field programmable gate array, a digital signal processor, or other suitable hardware. The “software” may comprise one or more objects, agents, threads, lines of code, subroutines, separate software applications, two or more lines of code or other suitable software structures operating in one or more software applications. For example, the controller 110 may execute machine readable program instructions for processing signals to and/or from other components of the MLN system 102 including the camera 106, the proximity sensors 108, or any other components (such as the motor) or devices operably coupled thereto.

The controller 110 may include, for example, microprocessors, microcomputers, microcontrollers, digital signal processors, central processing units, state machines, logic circuits, and/or any devices that may manipulate signals based on operational instructions. Among other capabilities, the controller 110 may be configured to fetch and execute computer readable instructions in communication with the data storage device 112. In one embodiment, the data storage device 112 may be configured to store, manage, or process communications in or between the MLN system 102 and the remote device. Examples of such communications include, but are not limited to, instructions, queries, data, and related metadata. The data storage device 112 may comprise any suitable computer-readable medium known in the art, related art, or developed later including, for example, volatile memory (e.g., RAM), non-volatile memory (e.g., flash drive), disk drive, etc., or any combinations thereof. Examples of the data storage device 112 may include, but are not limited to, a storage server, a portable storage device (e.g., a USB drive, an external hard drive, etc.), and so on. The storage server may be implemented as any of a variety of computing devices including, for example, a general-purpose or a special-purpose computing device, multiple networked servers (arranged in clusters or as a server farm), a mainframe, or so forth.

Further, in some embodiments, the controller 110 may be configured to convert the received communications into appropriate formats to make these communications compatible with a third-party data application, network devices, or interfaces, and vice versa. Consequently, the controller 110 may allow implementation of the data storage device 112 using different technologies or by different organizations, e.g., a third-party vendor, managing the data storage device 112 using a proprietary technology.

In one embodiment, the controller 110 may be configured to execute an exemplary method of localizing and autonomously navigating the mobile robot 100 without any priori/prior information and maps of the surrounding environment. The order in which the method is described here is not intended to be construed as a limitation, and any number of the described method steps may be combined, deleted, or otherwise performed in any order to implement these or an alternate set of instructions without departing from the concepts disclosed in the present application. The exemplary instructions may be described in the general context of computer-readable instructions, which may be stored on a computer readable medium, and installed or embedded in an appropriate device for execution. Further, the instructions may be implemented in any suitable hardware, software, firmware, or any combinations thereof known in the art, related art, or developed later.

At step 1, a target object is determined in a surrounding environment of the mobile robot 100. In one embodiment, the controller 110 may operate in communication with the camera 106 and the proximity sensors 108. The camera 106 may generate a video feed (or video stream) of a surrounding environment of the mobile robot 100. The video stream may be a single uncompressed red, green, blue (RGB) video stream with a predefined resolution (e.g., 1920×1080 pixels, 640×480 pixels, 1024×768 pixels, etc.) at preset frame rate such as 10 frames per second (fps), 20 fps, 30 fps, 40 fps, and 50 fps. In some examples, the predefined resolution may be higher or lower and the preset fps may be higher or lower. In some other examples, the controller 110 may trigger the camera to dynamically change (i.e., increase, decrease, or alternately switch between set values) the preset frame rate and/or the preset resolution of the camera and/or the video stream based on one or more aspects including, but not limited to, remote viewing, ambient lighting conditions, motion detection, power consumption by the underlying device (e.g., a camera device, mobile robot 110, a data storage device, etc.) connected to/with the camera 106, and a change in network bandwidth/congestion relative to a preset threshold value. In a further example, the video stream may be a greyscale video stream. The video stream may include a sequence of image frames captured over time by the camera 106. Each image frame may represent a visual scene corresponding to a surrounding environment of the mobile robot 100. In some examples, the video stream may include a single image frame. The generated video stream may be accessible by the controller 110. In some examples, the video stream may be stored, e.g., in the form of a data file, in the data storage device 112 for future access and/or retrieval by the controller 110.

In one embodiment, the controller 110 may be configured to access or receive a set of one or more image frames of the video stream or the data file. The controller 110 may analyze the video stream to detect and recognize objects in each of the image frames. The controller 110 may be configured to recognize a target object (e.g., a specific type of object such as “hospital bed”) based on a predefined target class (or target category such as “bed”). The target object (and the corresponding target class) may be predefined or dynamically defined by the controller 110 in communication with trained object data 210 in the data storage device 112. The trained object data 210 may include a group of objects and associated object categories. The target object (and the corresponding target class) may be defined, receive, or selected by the controller 110 based on a preset task to be performed by the mobile robot 100.

The controller 110 may employ any of a variety of object recognition techniques known in the art, related art, or developed later including, but not limited to, SSD (Single Shot Detector), CenterNet, FPN (Feature Pyramid Network), Faster R-CNN (Region-based Convolutional Neural Network), Detectron2Go, that are computationally light and operable for real-time object detection and recognition. In one example, the controller 110 may be configured to implement the YOLO (You Look Only Once) methodology to detect and recognize the target object in the surrounding environment of the mobile robot 100. In one implementation of the YOLO methodology, the controller 110 may divide an accessed or received image frame, such as an image frame 300 illustrated in FIG. 3, into a grid of cells. For each grid cell, the controller 110 may predict and/or determine (i) a probability of an object present in that grid cell and (ii) a bounding box coordinates of the object relative to the grid cell. For this, the controller 110 may cluster similar data points (and the corresponding anchor boxes) together in each grid cell using the k-means clustering technique known in the art. Each data point may correspond to a center point (and dimensions in some examples) of the corresponding anchor box. In one example, each anchor box may have a predetermined shape and size learned by the controller 110 during training. Each anchor box may cover a range of aspect ratios and scales predefined in trained object data 210 stored in the data storage device 112. The trained object data 210 may include object classes (or object categories) along with the aspect ratios and the scales associated with different known objects used for training the controller 110.

The clustered data points may represent different aspect ratios and scales, which may indicate the presence of objects in the image frame 300. The clustering of data points may cause the corresponding anchor boxes to overlap with each other in each grid cell. The controller 110 may, (i) in each grid cell, assign all objects to a principal anchor box having the highest overlap and (ii) predict/create a bounding box in that grid cell based on the principal anchor box. Each bounding box may be represented by a set of coordinates that may define the location and size of that bounding box relative to the underlying grid cell. For each grid cell, the controller 110 may predict multiple bounding boxes, each associated with a specific principal anchor box. These predicted bounding boxes may represent the likely location and size of objects in the grid cell relative to the corresponding principal anchor box. The controller 110 may then adjust the predicted bounding box coordinates based on the center point and dimensions of the principal anchor box. The adjusted bounding box coordinates may be used by the controller 110 to determine a location and size of an object within the image frame 300.

In some examples, the controller 110 may calculate a confidence score for each predicted bounding box using a predefined logistic regression function, which may output a value between 0 and 1 based on the features of the object in the box. For instance, the controller 110 may calculate the confidence score by multiplying a probability of an object being present in the predicted bounding box with the intersection over union (IoU) score between the predicted bounding box and a ground-truth bounding box. In one example, the ground-truth bounding box may be predetermined by the controller 110 based on the trained object data 210.

Once the confidence scores are calculated for all the predicted bounding boxes in a grid cell, the controller 110 may select the bounding box with the highest confidence score as the sub-final bounding box for the object in that cell. The sub-final bounding box may represent the most likely location and size of the object in that grid cell. Similarly, the sub-final bounding box may be determined by the controller 110 for all the grid cells and collectively provide a final bounding box, such as a bounding box 302 illustrated in FIG. 3. The final bounding box such as the bounding box 302 may represent the location and size of the object in that image frame 300.

After the object is detected in the image frame 300, as discussed above, the controller 110 may determine whether or not the detected object is a target object. The detected object may be associated with a predefined object class (or object category) in the trained object data 210. The controller 110 may compare the predefined object class with a predefined or dynamically defined target class to determine whether or not the detected object is the target object. For instance, when “bed” is predefined as the target class (or category), the controller 110 may determine the detected object as the target object based on “bed” being the predefined object class of the detected object. On the other hand, the controller 110 may set the detected object as an obstacle if the predefined object class of the detected object is either different from the target class or unavailable in the trained object data 210.

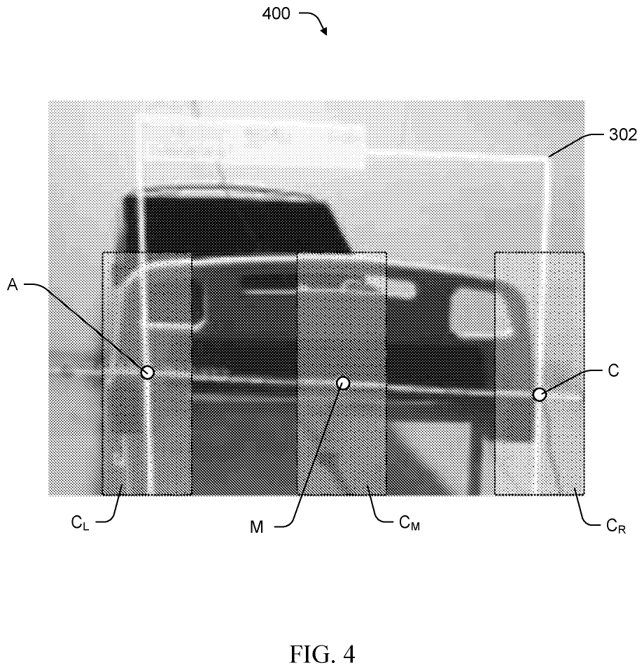

At step 2, edges of the recognized target object closest to the mobile robot 100 are determined. The controller 110 may determine edges of the recognized target object such as a bed 304 based on any suitable techniques known in the art including K-means clustering, and spectral clustering. In one embodiment, for example, as illustrated in FIG. 4, the controller 110 may be preconfigured or dynamically configured to determine a set of clusters of data points related to a portion of the target object such as the bed 304, where the portion may be closest to the mobile robot 100 or the camera 106 operably connected thereto. The controller 110 may be configured to determine a distance to different portions (or surfaces) of the target object using any suitable computer vision algorithms known in the art including, but not limited to, time-of-flight measurements, phase shift modulation, Scale-Invariant Feature Transform (SIFT), Monocular Depth Estimation using convolutional neural network (CNN). The portion of the target object having a minimum or shortest distance from the camera 106 may be considered closest to the mobile robot 110 (or the camera 106) by the controller 110. In some examples, the portion may be located within a predefined threshold distance (e.g., approximately 1 meter, approximately 2 meters, etc.) from the camera. In one example, the set of clusters may include a first cluster C_{L}, a second cluster C_{R}, and a third cluster C_{M} therebetween. The first cluster C_{L} may correspond to a left edge of the closest portion of the target object. The second cluster C_{R} may correspond to a right edge of the closest portion of the target object. The third cluster C_{M} may correspond to a middle cluster between the first cluster C_{L} and the second cluster C_{R} (hereinafter collectively referred to as lateral clusters). Each of the first cluster C_{L}, the second cluster C_{R}, and the third cluster C_{M} (hereinafter collectively referred to as cluster set Cs) may correspond to a 3D point cloud including the data points. Each of the clusters in the cluster set Cs may be determined by the controller 110 based on a Euclidean distance of each of the data points to a center point (or centroid) in that cluster. The controller 110 may initially select the centroid randomly in each cluster based on feature characteristics (e.g., shape, size, dimensions, etc.) of the left edge of the bed 304, i.e., the target object. For example, each data point proximate to the left edge may then be assigned to a general centroid by the controller 110 based on the corresponding Euclidean distance thereto, thereby creating the first cluster C_{L} with the general centroid acting as a center of the underlying cluster C_{L}. In general, a Euclidean distance may refer to a distance between a data point and its nearest centroid. The position of the general centroid may be updated by the controller 110 by calculating a mean of all data points within the first cluster C_{L} to move the general centroid towards a center of the data points for reducing the total variation (i.e., the Euclidean distance) within the cluster C_{L}. The controller 110 may repeat the assignment and update steps until a position of the general centroid no longer changes significantly, i.e., a difference between Euclidean distances corresponding to different data points from the general centroid is within a preset threshold value. When this difference for all data points falls within the preset threshold value, the controller 110 determines that the general centroid has reached a stable position to provide a centroid A representing a final or real center of the first cluster C_{L}, shown in Equation 1.

$$A = {C}_{L min} = ( {x}_{A} , {y}_{A} , {z}_{A} ) \qquad ( 1 )$$

where,
A=centroid of the first cluster C_{L}
C_{Lmin}=minimum distance point of the first cluster C_{L}
(x_{A}, y_{A}, z_{A})=coordinates of the centroid A

In the above Equation 1, the centroid A may represent the left edge of the bed 304, i.e., the target object. Similarly, the controller 110 may create the second cluster C_{R} corresponding to the right edge of the bed 304, i.e., the target object, where the second cluster C_{R} may have a centroid C, as shown in Equation 2.

$$C = {C}_{R min} = ( {x}_{C} , {y}_{C} , {z}_{C} ) \qquad ( 2 )$$

where,
C=centroid of the second cluster C_{R}
C_{Rmin}=minimum distance point of the second cluster C_{R}
(x_{C}, y_{C}, z_{C})=coordinates of the centroid C

In the above Equation 2, the centroid C may represent the right edge of the bed 304, i.e., the target object. The controller 110 may also create the third cluster C_{M} corresponding to a mid-section between the left edge and the right edge of the bed 304, i.e., the target object, in a similar manner as discussed above, where the third cluster C_{M} may have a centroid M, as shown in Equation 3. The mid-section may include a mid-point between the left edge and right edge of the bed 304.

$$M = {C}_{M min} = ( {x}_{M} , {y}_{M} , {z}_{M} ) \qquad ( 3 )$$

where,
M=centroid of the third cluster C_{M}
C_{Mmin}=minimum distance point of the third cluster C_{M}
(x_{M}, y_{M}, z_{M})=coordinates of the centroid M, where

$${x}_{M} = ( {x}_{A} + {x}_{C} ) / 2$$

$${y}_{M} = ( {y}_{A} + {y}_{C} ) / 2$$

$${z}_{M} = ( {z}_{A} + {z}_{C} ) / 2$$

In the above Equation 3, the centroid M may represent a mid-point between the left edge of the bed 304, i.e., the target object, represented by the centroid A and the right edge of the bed 304 represented by the centroid C. In some examples, the centroid M may include a center of an edge (or a surface or portion) extending between the left edge of the bed 304 and the right edge of the bed 304.

At step 3, an independent reference point D in a world coordinate system is defined. In one embodiment, the controller 110 may be configured to define an independent reference point D in a world coordinate system. In the present application, a coordinate system may refer to a set of axes used to specify a position (or motion) of a point (e.g., related to an object) in space, where each of the axes represents a different dimension of space in association with a unit of measure, such as distance.

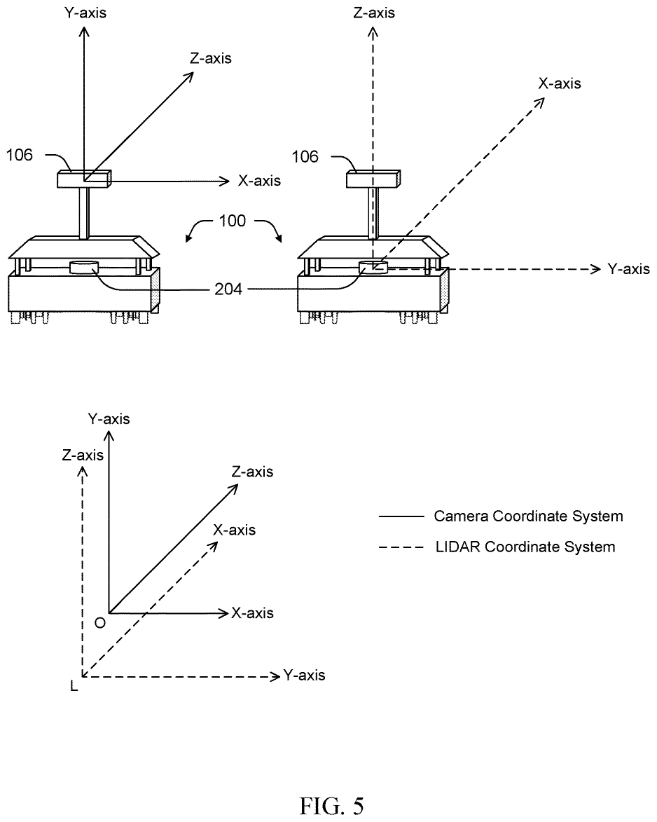

The independent reference point D may assist in eliminating any discrepancy in data from the different types of proximity sensors 108 due to a difference in the respective coordinate systems of the camera 106 and the proximity sensors 108 such as the LIDAR sensor 204. For example, as illustrated in FIG. 5, a coordinate system of the camera 106 may include a 3D coordinate system shown using solid lines. On the other hand, a coordinate system of the proximity sensors 108 such as the LIDAR sensor 204 may include a LIDAR coordinate system shown as dashed lines. The camera coordinate system may be in Cartesian coordinate system and defined as: x-axis extending in a horizontal direction, y-axis extending in a vertical direction, and z-axis extending along a direction (e.g., forward/reverse direction) perpendicular to the x-axis and the y-axis. In one example, the camera coordinate system may have an origin (or a center) O at a location of the camera 106, e.g., on the mobile robot 100. On the other hand, the LIDAR coordinate system may be in a polar coordinate system and defined as: y-axis extending in the horizontal direction, z-axis extending in the vertical direction, and x-axis extending along a direction (e.g., forward/reverse direction) perpendicular to the y-axis and the z-axis. In one example, the LIDAR coordinate system may have an origin (or a center) L at a location (or base link) of the LIDAR sensor 204, e.g., on the mobile robot 100. In some examples, the camera 106 (or an image frame generated/captured by the camera 106) may be parallel to the ground or a horizontal axis of the mobile robot 100; however, other examples may include the camera 106 (or the generated/captured image frame) being inclined at a preset or dynamically set tilt angle with respect to the ground or the horizontal axis of the mobile robot 100.

Due to the difference in the respective coordinate systems of the camera 106 and the LIDAR sensor 204, observed parameters of the target object (e.g., bed 304) determined based on camera data may conflict, or become incompatible, with those same parameters when calculated using the LIDAR data in connection with the LIDAR sensor 204, thereby increasing the computational burden and the risk of operational failure of the mobile robot 100. Examples of the observed parameters may include, but are not limited to, (i) a distance between the target object and the mobile robot 100, (ii) relative position or relative orientation of the target object with respect to the mobile robot 100, or vice versa, (iii) relative position or relative orientation of the mobile robot 100 with respect to a target point associated with the target object, or vice versa, etc. Hence, the independent reference point D in the world coordinate system may provide a standard, or neutral/common, reference system to assist the controller 110 in accurately determining positions and orientations of the mobile robot 100, e.g., during navigation, thereby enabling self-localization of the mobile robot 100 without a map or any other priori information of the surrounding environment. In one example, the world coordinate system may include an origin (or a center) different (or independent) from that of the camera coordinate system and the LIDAR coordinate system. For instance, the world coordinate system may have an origin (or a center) at the independent reference point D.

In one embodiment, the controller 110 may define the independent reference point D as the center of each of the image frames in the video stream received from the camera 106, as shown in Equation 4.

$$D = ( {I}_{x} , {I}_{y} ) = ( {x}_{D} , {y}_{D} , {z}_{D} ) \qquad ( 4 )$$

where,
D=center of an image frame
(Iₓ, I_{y})=(pixel width, pixel height)=a location of the independent reference point D in the image frame
(x_{D}, y_{D}, z_{D})=3D coordinates of the independent reference point D in the world coordinate system

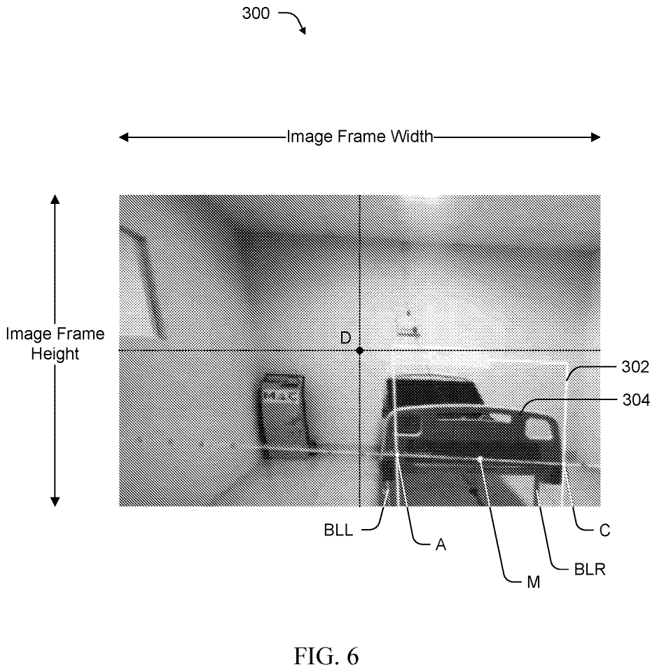

In the above Equation 4, the center of the image frame, i.e., the independent reference point D, may have x-coordinate (x_{D}) extending along a horizontal direction, y-coordinate (y_{D}) extending along a vertical direction, and z-coordinate (z_{D}) extending along a direction (e.g., forward/reverse direction) that is perpendicular to directions pertaining to x_{D} and y_{D}. The independent reference point D may be set based on a frame height, I_{y}, and a frame width, Iₓ, of the underlying image frame such as the image frame 300. For example, as illustrated in FIG. 6, the independent reference point D may be located at I corresponding to a half of the width of the image frame 300 and I_{y} corresponding to a half of the height of the image frame 300, as shown in Equation 5 and Equation 6. For instance, each image frame such as the image frame 300 may have a frame height equal to 1080 pixels and a frame width equal to 1920 pixels depending on the camera resolution, e.g., 1920×1080 pixels. Hence, the controller 110 may determine the independent reference point D being located in each image frame such as the image frame 300 at (i) the frame width, Ix, equal to 960 pixels, and (ii) the frame height, Iy, equal to 540.

$${I}_{x} = Frame Width / 2 \qquad ( 5 )$$

$${I}_{y} = Frame Height / 2 \qquad ( 6 )$$

where,
Frame Width=width of the image frame (e.g., in pixels)
Frame Height=height of the image frame (e.g., in pixels)

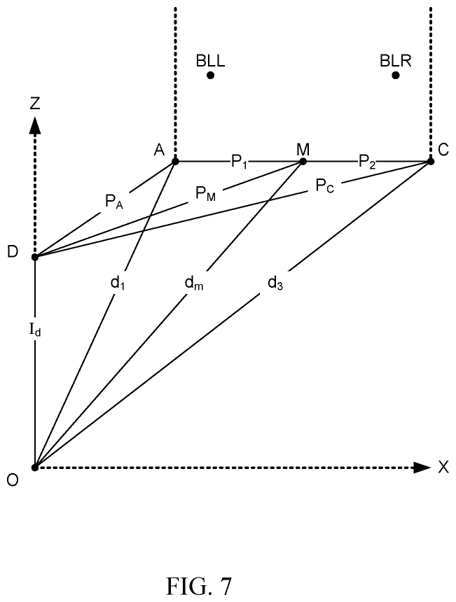

At step 4, target points corresponding to the closest edges of the recognized target object are determined based on the independent reference point D. In one embodiment, as illustrated in FIG. 7, the target object such as the bed 304 may have the left edge A (corresponding to the centroid A), the right edge C (corresponding to the centroid C), and the mid-point M (corresponding to the centroid M) therebetween, as discussed above. In some examples, the left edge A may be offset from a left leg of the bed 304, shown as BLL (bed leg left). Similarly, the right edge C may be offset from a right leg of the bed 304, shown as BLR (bed leg right). For instance, each of the left leg, BLL, and the right leg, BLR, (hereinafter collectively referred to as bed legs) may be located between the left edge A and the right edge C. However, the camera 106 may capture each of the bed legs as a part of the closest cluster of data points due to the close proximity therebetween. For instance, the bed left leg BLL may be captured by the camera 106 as a part of the first cluster C_{L} related to the left edge of the bed 304. Similarly, the bed right leg BLR may be captured by the camera 106 as a part of the second cluster C_{R} related to the right edge of the bed 304. Hence, the controller 110 may be preconfigured or dynamically configured to define the target object, such as the bed 304, in terms of the target point A (i.e., representing the left edge), the target point C (i.e., representing the right edge), and the target point M (i.e., representing the mid-point between the left edge A and the right edge C). These target points A, M, C may provide to a first set of target points in the camera coordinate system. In the illustrated example of FIG. 6, each of the first set of target points are shown on the same side (e.g., a front side) of the bed 304 for the sake of simplicity. However, some examples may include the first set having the underlying target points distributed on different sides of the bed 304, i.e., the target object.

In one embodiment, the controller 110 may determine a second set of target points in the world coordinate system based on the first set of target points A, C, and M of the target object such as the bed 304 from a frame of reference of the camera 106 (i.e., camera frame point O) in the camera coordinate system. The second set of target points may be determined with respect to the predetermined independent reference point D in the world coordinate system. In the present application, a frame of reference may refer to a point of view for observing all other points in space. In some examples, the frame of reference (or reference point) may include a point of origin relative to which all other points in space may be observed or specified. The point of origin (or the frame of reference) may be represented in a unit of measure of the corresponding coordinate system. For instance, the point of origin (or the frame of reference) may be represented using coordinates (0, 0, 0) in the Cartesian coordinate system (such as the camera coordinate system), thereby indicating that a distance along each of the x-axis, y-axis, and z-axis is zero. The frame of reference may assist in describing a position and orientation (or motion in some instances) of the target object, such as the bed 304.

To determine the second set of target points, in the illustrated example of FIG. 7, the camera frame point O may have the coordinates (x_{O}, y_{O}, z_{O}). Since there is no movement of the target object such as the bed 304 and the mobile robot 100 in a vertical direction, i.e., along the y-axis, with respect to the camera frame point O (i.e., in the camera coordinate system), the y-component in (i) each of the first set of target points A, C, M, (ii) the camera frame point O, and (iii) the determined independent reference point D may be considered zero, as shown in Equations 7-11.

$$A = ( {x}_{A} , {y}_{A} , {z}_{A} ) ⇒ A = ( {x}_{A} , {z}_{A} ) where {y}_{A} = 0 \qquad ( 7 )$$

$$C = ( {x}_{C} , {y}_{C} , {z}_{C} ) ⇒ C = ( {x}_{C} , {z}_{C} ) where {y}_{C} = 0 \qquad ( 8 )$$

$$M = ( {x}_{M} , {y}_{M} , {z}_{M} ) ⇒ M = ( {x}_{M} , {z}_{M} ) where {y}_{M} = 0 \qquad ( 9 )$$

$$D = ( {x}_{D} , {y}_{D} , {z}_{D} ) ⇒ D = ( {x}_{D} , {z}_{D} ) where {y}_{D} = 0 \qquad ( 10 )$$

$$O = ( {x}_{O} , {y}_{O} , {z}_{O} ) ⇒ O = ( {x}_{O} , {z}_{O} ) where {y}_{O} = 0 \qquad ( 11 )$$

Further, in the illustrated example of FIG. 7, the controller 110 may calculate an angle (or camera angle) at the camera frame point O between the independent reference point D and each of the target points based on the cosine rule formula providing a generalized equation 12. The camera angle may define an orientation of the camera 106 (or the mobile robot 100) with respect to the independent reference point D.

$$Cos ( γ ) = ( {b}^{2} + {c}^{2} - {a}^{2} ) / ( 2 * b * c ) \qquad ( 12 )$$

where,
‘b’=length (or Euclidean distance) between a first point and a second point
‘c’=length (or Euclidean distance) between a first point and a third point
‘a’=length (or Euclidean distance) between the second point and the third point
‘γ’=angle opposite to length ‘a’ (i.e., angle between ‘b’ and ‘c’)

In the illustrated example of FIG. 7, to determine the camera angle γ, the controller 110 may calculate (i) a first set of Euclidean distances from the camera frame point O to each of the target points and (ii) a second set of Euclidean distances between the independent reference point D and each of the target points, and (iii) a third set of Euclidean distances between each of the target points. In one example, a Euclidean distance between any two points may be calculated by finding the differences between their x, y, and z coordinates, squaring each difference, summing the squares, and taking a square root of the sum. For example, the controller 110 may calculate the first set of Euclidean distances with respect to the camera frame point O using Equations 13-16.

$$OD = {I}_{d} = \sqrt{{( {z}_{D} - {z}_{O} )}^{2} + {( {x}_{D} - {x}_{O} )}^{2}} \qquad ( 13 )$$

where,
I_{d}=Euclidean distance between the camera frame point O and the independent reference point D

$$O = ( {x}_{O} , {z}_{O} )$$

$$where$$

$${y}_{O} = 0$$

$$D = ( {x}_{D} , {z}_{D} )$$

$$where$$

$${y}_{D} = 0$$

$$OD = {d}_{1} = \sqrt{{( {z}_{A} - {z}_{O} )}^{2} + {( {x}_{A} - {x}_{O} )}^{2}} \qquad ( 14 )$$

where,
d₁=Euclidean distance between the camera frame point O and the target point A of the bed 304

$$O = ( {x}_{O} , {z}_{O} )$$

$$where$$

$${y}_{O} = 0$$

$$A = ( {x}_{A} , {z}_{A} )$$

$$where$$

$${y}_{A} = 0$$

$$OM = {d}_{m} = \sqrt{{( {z}_{M} - {z}_{O} )}^{2} + {( {x}_{M} - {x}_{O} )}^{2}} \qquad ( 15 )$$

where,
dₘ=Euclidean distance between the camera frame point O and the target point A of the bed 304

$$O = ( {x}_{O} , {z}_{O} )$$

$$where$$

$${y}_{O} = 0$$

$$M = ( {x}_{M} , {z}_{M} )$$

$$where$$

$${y}_{M} = 0$$

$$OC = {d}_{3} = \sqrt{{( {z}_{C} - {z}_{O} )}^{2} + {( {x}_{C} - {x}_{O} )}^{2}} \qquad ( 16 )$$

where,
dₘ=Euclidean distance between the camera frame point O and the target point A of the bed 304

$$O = ( {x}_{O} , {z}_{O} )$$

$$where$$

$${y}_{O} = 0$$

$$C = ( {x}_{C} , {z}_{C} )$$

$$where$$

$${y}_{C} = 0$$

Similarly, in one example, the controller 110 may be preconfigured or dynamically configured to also calculate the second set of Euclidean distances with respect to the independent reference point D using Equations 17-19.

$$DA = {P}_{A} = \sqrt{{( {z}_{A} - {z}_{D} )}^{2} + {( {x}_{A} - {x}_{D} )}^{2}} \qquad ( 17 )$$

where,
P_{A}=Euclidean distance between the independent reference point D and the target point A of the bed 304

$$D = ( {x}_{D} , {z}_{D} )$$

$$where$$

$${y}_{D} = 0$$

$$A = ( {x}_{A} , {z}_{A} )$$

$$where$$

$${y}_{A} = 0$$

$$DM = {P}_{M} = \sqrt{{( {z}_{M} - {z}_{D} )}^{2} + {( {x}_{M} - {x}_{D} )}^{2}} \qquad ( 18 )$$

where,
P_{M}=Euclidean distance between the independent reference point D and the mid-point M of the bed 304

$$D = ( {x}_{D} , {z}_{D} )$$

$$where$$

$${y}_{D} = 0$$

$$M = ( {x}_{M} , {z}_{M} )$$

$$where$$

$${y}_{M} = 0$$

$$DC = {P}_{C} = \sqrt{{( {z}_{C} - {z}_{D} )}^{2} + {( {x}_{C} - {x}_{D} )}^{2}} \qquad ( 19 )$$

where,
P_{C}=Euclidean distance between the independent reference point D and the target point C of the bed 304

$$D = ( {x}_{D} , {z}_{D} )$$

$$where$$

$${y}_{D} = 0$$

$$C = ( {x}_{C} , {z}_{C} )$$

$$where$$

$${y}_{C} = 0$$

Further, in one example, the controller 110 may be preconfigured or dynamically configured to also calculate the third set of Euclidean distances using Equations 20-21.

$$AM = {P}_{1} = \sqrt{{( {z}_{M} - {z}_{A} )}^{2} + {( {x}_{M} - {x}_{A} )}^{2}} \qquad ( 20 )$$

where,
P₁=Euclidean distance between the target point A of the bed 304 and the mid-point M of the bed 304

$$A = ( {x}_{A} , {z}_{A} )$$

$$where$$

$${y}_{A} = 0$$

$$M = ( {x}_{M} , {z}_{M} )$$

$$where$$

$${y}_{M} = 0$$

$$MC = {P}_{2} = \sqrt{{( {z}_{C} - {z}_{M} )}^{2} + {( {x}_{C} - {x}_{M} )}^{2}} \qquad ( 21 )$$

where,
P₂=Euclidean distance between the target point A of the bed 304 and the mid-point M of the bed 304

$$M = ( {x}_{M} , {z}_{M} )$$

$$where$$

$${y}_{M} = 0$$

$$C = ( {x}_{C} , {z}_{C} )$$

$$where$$

$${y}_{C} = 0$$

In one embodiment, the controller 110 may be configured to calculate a set of camera angles based on the independent reference point D using the generalized equation 12 mentioned above. Each of the camera angles may assist in determining an orientation of the camera 106 (or the mobile robot 100) with respect to the first set of target points of the bed 304, i.e., the target object. In one example, the controller 110 may calculate a first camera angle γ_{A} as shown in Equation 22. The first camera angle γ4 may correspond to an orientation angle of the camera 106 (or the mobile robot 100) with respect to the target point A of the bed 304, i.e., the target object, based on a relative position of the independent reference point D.

$$∠ DOA = {γ}_{A} = {Cos}^{- 1} ( ( {{I}_{d}}^{2} + {{d}_{1}}^{2} - {{P}_{A}}^{2} ) / ( 2 * {I}_{d} * {d}_{1} ) ) \qquad ( 22 )$$

where,
I_{d}=Euclidean distance between the camera frame point O and the independent reference point D
d₁=Euclidean distance between the camera frame point O and the target point A of the bed 304
P_{A}=Euclidean distance between the independent reference point D and the target point A of the bed 304

Similarly, the controller 110 may be configured to calculate a second camera angle γ_{M} as shown in Equation 23. The second camera angle γ_{M} may correspond to an orientation angle of the camera 106 (or the mobile robot 100) with respect to the mid-point M of the bed 304, i.e., the target object, based on a relative position of the independent reference point D.

$$∠ DOM = {γ}_{M} = {Cos}^{- 1} ( ( {{I}_{d}}^{2} + {{d}_{M}}^{2} - {{P}_{M}}^{2} ) / ( 2 * {I}_{d} * {d}_{M} ) ) \qquad ( 23 )$$

where,
I_{d}=Euclidean distance between the camera frame point O and the independent reference point D
dₘ=Euclidean distance between the camera frame point O and the target point A of the bed 304
P_{M}=Euclidean distance between the independent reference point D and the mid-point M of the bed 304

Further, the controller 110 may be configured to calculate a third camera angle γ_{C} as shown in Equation 24. The third camera angle γ_{C} may correspond to an orientation angle of the camera 106 (or the mobile robot 100) with respect to the target point C of the bed 304, i.e., the target object, based on a relative position of the independent reference point D.

$$∠ DOC = {γ}_{C} = {Cos}^{- 1} ( ( {I}_{d}^{2} + {d}_{3}^{2} - {P}_{C}^{2} ) / ( 2 * {I}_{d} * {d}_{3} ) ) \qquad ( 24 )$$

where,
I_{d}=Euclidean distance between the camera frame point O and the independent reference point D
dₘ=Euclidean distance between the camera frame point O and the target point A of the bed 304
P_{M}=Euclidean distance between the independent reference point D and the mid-point M of the bed 304

In one embodiment, the controller 110 may be configured to also calculate a fourth camera angle θ_{A} as shown in Equation 25. The fourth camera angle θ_{A} may correspond to an orientation angle of the camera 106 (or the mobile robot 100) based on relative positions of the target point A of the bed 304 and the mid-point M of the bed 304.

$$∠ AOM = {θ}_{A} = abs ( {γ}_{M} - {γ}_{A} ) \qquad ( 25 )$$

Similarly, the controller 110 may further calculate a fifth camera angle θ_{C} as shown in Equation 26. The fifth camera angle θ_{C} may correspond to an orientation angle of the camera 106 (or the mobile robot 100) based on relative positions of the mid-point M of the bed 304 and the target point C of the bed 304.

$$∠ MOC = {θ}_{C} = abs ( {γ}_{M} - {γ}_{C} ) \qquad ( 26 )$$

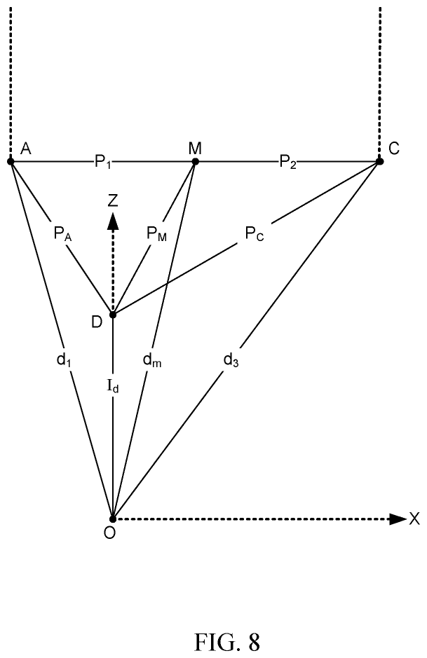

In one embodiment, when the controller 110 may move the mobile robot 100, the polarity of the set of camera angles may change based on a position of the independent reference point D relative to the first set of target points A, C, M. For example, as illustrated in FIG. 8, the camera 106 (or the mobile robot 100) may be oriented such that the independent reference point D may be positioned between the target point A of the bed 304 and the mid-point M of the bed 304, thereby indicating a rightward movement of the independent reference point D along the x-axis of the camera coordinate system and relatively close to the mid-point M of the bed 304. Due to such orientation of the camera 106, in a first condition (shown in Equation 27), the target point A of the bed 304 may be located to the left of the camera frame point O (and the independent reference point D) while the mid-point M and the target point C of the bed 304 may be located to the right of the camera frame point O (and the independent reference point D). Based on the relative position of the target point A of the bed 304, the controller 110 may assign a negative polarity to the calculated first camera angle γ_{A}. As a result, values of the camera angle related to the first camera angle γ_{A} may also be accordingly modified or updated by the controller 110, as shown in Equation 27.

$$Condition - 1 :$$

$$\begin{matrix}If ( {x}_{A} < 0 \&\& {x}_{M} > 0 \&\& {x}_{C} > 0 ) \\ Then : {γ}_{A} = - {γ}_{A} ; {γ}_{M} = {γ}_{M} ; {γ}_{C} = {γ}_{C} ; {θ}_{A} = abs ( {γ}_{M} + {γ}_{A} ) ; {θ}_{C} = abs ( {γ}_{M} - {γ}_{C} )\end{matrix} \qquad ( 27 )$$

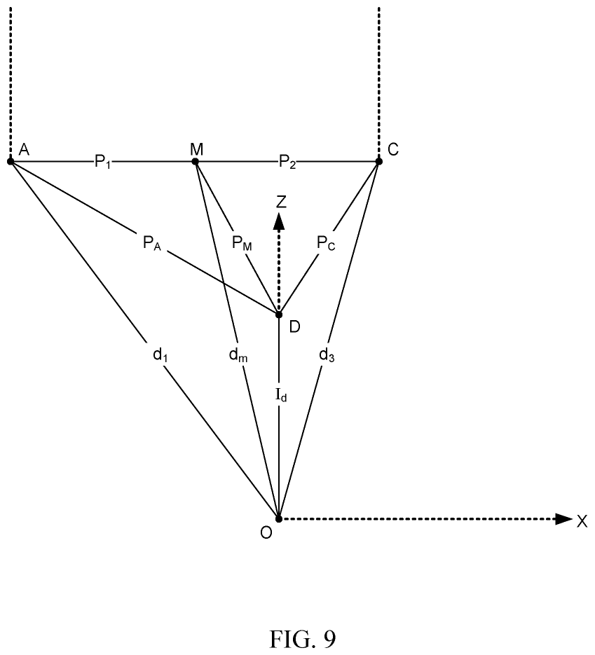

Similarly, as illustrated in FIG. 9, the camera 106 (or the mobile robot 100) may be oriented such that the independent reference point D may be positioned between the mid-point M of the bed 304 and the target point C of the bed 304, thereby indicating a further rightward movement of the independent reference point D along the x-axis of the camera coordinate system and relatively close to the target point C of the bed 304. Due to such orientation of the camera 106, in a second condition (shown in Equation 28), the target point A of the bed 304 and the mid-point M of the bed 304 may be located to the left of the camera frame point O (and the independent reference point D) while the target point C of the bed 304 may be located to the right of the camera frame point O (and the independent reference point D). Based on the relative positions of the target point A of the bed 304 and the mid-point M of the bed 304, the controller 110 may assign a negative polarity to the calculated values of the first camera angle γ_{A} and the second camera angle γ_{M}. As a result, values of the camera angle related to the first camera angle γ_{A} and the second camera angle γ_{M} may also be accordingly modified or updated by the controller 110, as shown in Equation 28.

$$Condition - 2 :$$

$$\begin{matrix}If ( {x}_{A} < 0 \&\& {x}_{M} > 0 \&\& {x}_{C} > 0 ) \\ Then : {γ}_{A} = - {γ}_{A} ; {γ}_{M} = - {γ}_{M} ; {γ}_{C} = {γ}_{C} ; {θ}_{A} = abs ( - {γ}_{M} + {γ}_{A} ) ; {θ}_{C} = abs ( - {γ}_{M} - {γ}_{C} )\end{matrix} \qquad ( 28 )$$

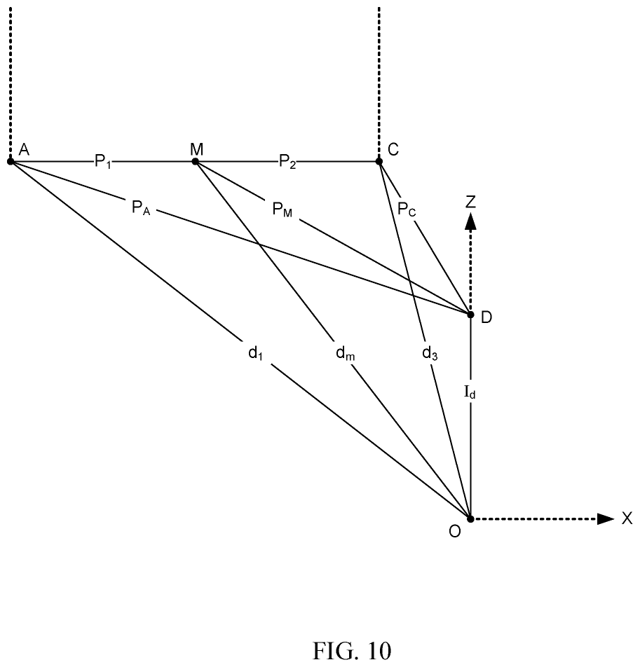

Further, as illustrated in FIG. 10, the camera 106 (or the mobile robot 100) may be oriented such that the independent reference point D may be positioned to the right of the target point C of the bed 304, thereby indicating a further rightward movement of the independent reference point D along the x-axis of the camera coordinate system to move substantially away from the target point A of the bed 304. Due to such orientation of the camera 106, in a third condition (shown in Equation 29), all of the target points A, M, C may be located to the left of the camera frame point O (and the independent reference point D). Based on such relative positions of the target points, the controller 110 may assign a negative polarity to the calculated values of the first camera angle γ_{A}, the second camera angle γ_{M}, and the third camera angle γ_{C}. As a result, values of the camera angle related to the first camera angle γ_{A}, the second camera angle γ_{M}, and the third camera angle γ_{C} may also be accordingly modified or updated by the controller 110, as shown in Equation 29.

$$Condition - 3 :$$

$$\begin{matrix}If ( {x}_{A} < 0 \&\& {x}_{M} > 0 \&\& {x}_{C} < 0 ) \\ Then : {γ}_{A} = - {γ}_{A} ; {γ}_{M} = - {γ}_{M} ; {γ}_{C} = - {γ}_{C} ; {θ}_{A} = abs ( - {γ}_{M} + {γ}_{A} ) ; {θ}_{C} = abs ( - {γ}_{M} + {γ}_{C} )\end{matrix} \qquad ( 29 )$$

Based on the calculated values camera angles γ_{A}, γ_{B}, and γ_{C}, the controller 110 may be configured to determine the second set of target points A1, M1, and C1 in the world coordinate system, i.e., with respect to the independent reference point D. The second set of target points A1, M1, C1 may be determined in the polar coordinate system to make them compatible with data values received from the LIDAR sensor 204 for a bump-free autonomous robot navigation by maintaining a predetermined distance between the mobile robot 100 and (i) the bed 304 or (ii) the underlying target points A1, M1, C1, discussed below in greater detail. For example, the controller 110 may determine the coordinates of the target point A1 with respect to the reference point D, as shown in Equation 30.

$$A 1 = ( gpxA , gpzA ) \qquad ( 30 )$$

where,
gpxA=d₁*sin(γ_{A})=x-coordinate of target point A1 with respect to the reference point D;
gpzA=d₁*cos(γ_{A})=z-coordinate of target point A1 with respect to the reference point D;

In equation 30, the x-coordinate and the z-coordinate of the target point A1 may be determined by the controller 110 by using the distance d₁ between the camera frame point O and the target point A (in the first set) which was determined in the camera coordinate system. The distance d₁ may be determined by the controller 110 using any suitable computer vision algorithms known in the art such as those mentioned above. Similarly, the controller 110 may determine the coordinates of the target point M1 with respect to the reference point D, as shown in Equation 31.

$$M 1 = ( gpxM , gpzM ) \qquad ( 31 )$$

where,
gpxM=dₘ*sin(γ_{M})=x-coordinate of target point M1 with respect to the reference point D;
gpzM=dₘ*cos(γ_{M})=z-coordinate of target point M1 with respect to the reference point D;

In equation 31, the x-coordinate and the z-coordinate of the target point M1 may be determined by the controller 110 by using the distance dₘ between the camera frame point O and the target point M (in the first set) which was determined in the camara coordinate system. The distance dₘ may be determined by the controller 110 using any suitable computer vision algorithms known in the art such as those mentioned above. The controller 110 may further determine the coordinates of the target point C1 with respect to the reference point D, as shown in Equation 32.

$$C 1 = ( gpxC , gpzC ) \qquad ( 32 )$$

where,
gpxC=d₃*sin(γ_{c})=x-coordinate of target point C1 with respect to the reference point D;
gpzC=d₃*cos(γ_{c})=x-coordinate of target point C1 with respect to the reference point D;

In equation 32, the x-coordinate and the z-coordinate of the target point C1 may be determined by the controller 110 by using the distance d₃ between the camera frame point O and the target point C (in the first set) which was determined in the camara coordinate system. The distance d₃ may be determined by the controller 110 using any suitable computer vision algorithms known in the art such as those mentioned above. The points A1, M1, C1 define the second set of target points with respect to the independent reference point D in the world coordinate system for the bed 304, i.e., the target object. In one example, the target point A1 may include the target point A, the target point C1 may include the target point C, and the target point M1 may include the target point M. Thus, the second set of target points A1, M1, C1 assist in localizing the mobile robot 100 in the world coordinate system.

Similar to the second set of target points A1, M1, C1 determined for a front side (or front edge of the bed 304), the controller 110 may determine the second set of target points in the world coordinate system for other sides (or edges) of the bed 304. Hence, the second set of target points A1, M1, C1 in the world coordinate system may assist in localizing the mobile robot 100 in different spatial positions without the need of any priori/prior information (e.g., maps) of the surrounding environment of the mobile robot 100.

At step 5, target points corresponding to the closest edges of the recognized target object are determined with respect to a LIDAR frame L. The controller 110 may determine the target object such as the bed 304 with respect to a frame of reference of the LIDAR sensor 204 (hereinafter referred to as LIDAR frame L) for easy navigation of the mobile robot 100. Since there is no movement of the target object such as the bed 304 and the mobile robot 100 in a vertical direction, i.e., along the z-axis as shown above in FIG. 5, with respect to the LIDAR frame L, the z-component in (i) each of the target points A, C, M, and (ii) the LIDAR frame L may be considered zero, as shown in Equations A1 to A3.

$$\cdot Coordinates of A = ( 1 \_x \_a , 1 \_y \_a , 1 \_z \_a ) ⇒ A = ( 1 \_x \_a , 1 \_y \_a where l\_z \_a = 0 \qquad ( E 1 )$$

$$\cdot Coordinates of M = ( 1 \_x \_m , 1 \_y \_m , 1 \_z \_m ) ⇒ M = ( 1 \_x \_m , 1 \_y \_m ) where l\_z \_m = 0 \qquad ( E 2 )$$

$$\cdot Coordinates of C = ( 1 \_x \_c , 1 \_y \_c , 1 \_z \_c ) ⇒ C = ( 1 \_x \_c , 1 \_y \_c where l\_z \_c = 0 \qquad ( E 3 )$$

In Equations E1-E3, the coordinates of the first set of target points A, C, M of the bed 304 are represented in the Cartesian coordinate system. Since the LIDAR coordinate system is a polar coordinate system, the LIDAR data would need to be converted into the Cartesian coordinate system to make the LIDAR data compatible/comparable with the camera data (e.g., the first set of target points with respect to camera frame point O). However, since using the camera data is computationally expensive and occupies a large memory space, such conversion of the LIDAR data to the Cartesian coordinate system would further increase the computation load and memory usage. Hence in one embodiment, the controller 110 may be configured to determine a third set of target points with respect to the LIDAR frame L (i.e., the LIDAR sensor 204). The third set of target points may refer to the second set of target points A1, M1, C1 in the world coordinate system now redetermined with respect to the LIDAR frame L (or the LIDAR coordinate system). By virtue of both LIDAR data and the second set of target points being in the polar coordinate system, the second set of target points A1, M1, C1 may be readily compatible with the LIDAR data, thereby avoiding computational and memory resource wastage. Each LIDAR data (or i^{th} index value) may be represented in cartesian coordinates (l_x, l_y) as shown by generalized equations 33-44.

$$l\_x = - l\_r * cos ( l\_a ) \qquad ( 33 )$$

$$l\_y = l\_r * sin ( l\_a ) \qquad ( 34 )$$

where:
l_r=LIDAR range (or distance) of i^{th} index value in LIDAR data
l_a=LIDAR's angle of i^{th} index value from x-axis
l_x=x-component of the i^{th} LIDAR data
l_y=y-component of the i^{th} LIDAR data

In Equations 33-34, l_r may correspond to a range or distance of the LIDAR sensor 204 at L_a^{th} angle to a point P in space and l_a may correspond to a measure of angle from the x-axis of the LIDAR frame L to a line segment indicated by l_r. Each i^{th} index value (or i^{th} LIDAR data value) may correspond to the point P having coordinates (l_x, l_y). The point P may represent a general point related to i^{th} LIDAR data value. The maximum number (i) of LIDAR data values may depend on a predefined range size of the LIDAR sensor 204, as shown in Equation 35.

$$l\_rs = range size = \frac{max\_ang - min\_ang}{angle increment} \qquad ( 35 )$$

where:
max_ang=maximum angle measurable by a sensor, such as LIDAR sensor 204
min_ang=minimum angle measurable by the sensor
angle increment=angular resolution of the sensor

In Equation 35, the range size (l_rs) may refer to a span or extent of angles measurable/measured by a sensor, such as the LIDAR sensor 204. In one example, the LIDAR sensor 204 may have a range size of 3240 based on having a maximum measurable angle (max_ang) of positive 3.14 radians (i.e., 180 degrees), a minimum measurable angle (min_ang) of negative 3.14 radians (i.e., −180 degrees), angular resolution (or angle increment) of 0.001939 radians (i.e., 0.11 degrees).

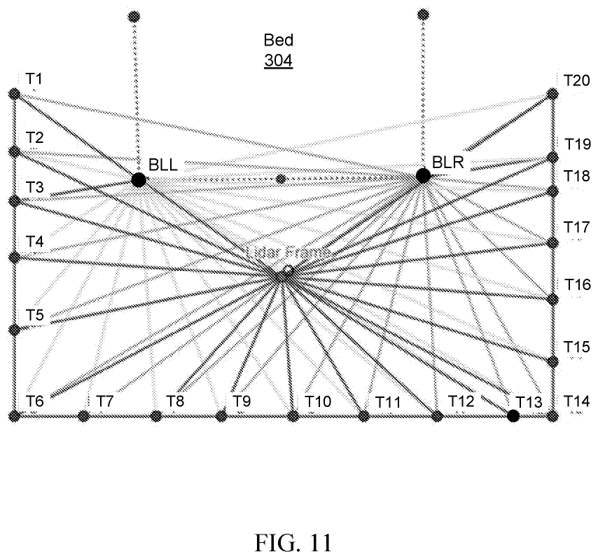

As illustrated in FIG. 11, in one example, the LIDAR sensor 204 may send optical signals in the surrounding environment of the mobile robot 100 and use the optical signals received after being reflected or bounced off a surface. For example, as illustrated, the LIDAR sensor 204 may use the reflected optical signals received after bouncing from surface points T1, T2, . . . , T20 (hereinafter collectively referred to as LIDAR points T) in the surrounding environment to provide LIDAR data corresponding to the LIDAR points T. Each i^{th} index value of the LIDAR data may correspond to i^{th} LIDAR point (l_x, l_y) in the LIDAR points T. For instance, the first LIDAR data (i.e., i=1) may comprise a first range and first angle corresponding to the surface point T1, the second LIDAR data (i.e., i=2) may comprise a second range and second angle corresponding to the surface point T2, and so on till LIDAR data for i=T.

In one embodiment, the controller 110 may be configured to determine LIDAR data that substantially corresponds to (or located proximate to) each of the second set of target points A1 and C1 previously identified with respect to the reference point D. The target point A1 may correspond to a left edge of the bed 304 and the target point C1 may correspond to a right edge of the bed 304, both with respect to the reference point D. As illustrated in FIG. 11, the target point A1 (or the left edge) may be proximate to a left leg (BLL) of the bed 304. Similarly, the target point C1 (or the right edge) may be proximate to a right leg (BLR) of the bed 304. Since the LIDAR sensor 204 is a 2D sensor in a plane below the camera 106, the LIDAR sensor 204 may only see the bed legs BLL and BLR instead of the target points A1 and C1. Thus, the controller 110 may correlate each of the target points A1 and C1 with the corresponding LIDAR data as the clusters related to the target points A1, C1 include the proximate bed legs BLL and BLR respectively, as discussed above, thereby determining the target point A1 (or the left leg BLL) and the target point C1 (or the right leg BLR) with respect to the LIDAR frame L. In one example, the controller 110 may be configured to determine the third set of target points A2 and C2 with respect to the LIDAR frame L (i.e., a location of the LIDAR sensor 204) based on a Euclidean distance (dlc) from an intended target point (such as the target point A1, C1) to each of the LIDAR points T. The Euclidean distance (dlc) may be calculated using the generalized equation B1.

$$dlc = \sqrt{{( l\_x - gpz )}^{2} + {( l\_y - gpx )}^{2}} \qquad ( B 1 )$$

where:
dlc=Euclidean distance between i^{th} LIDAR point and a target point
l_x=−l_r*Cos(l_a)=x-coordinate of i^{th} LIDAR data corresponding to i^{th} LIDAR point
l_y=l_r*Sin(l_a)=y-coordinate of i^{th} LIDAR data corresponding to i^{th} LIDAR point
gpx=x-coordinate of the target point with respect to the reference point D
gpz=z-coordinate of the target point with respect to the reference point D

Based on Equation B1, the controller 110 may be configured to determine a first LIDAR dataset F1 including Euclidean distances between each of the LIDAR points T and the target point A1, as shown in Equation 36-1. The first LIDAR dataset F1 may include one or more values of Euclidean distances depending on the number of LIDAR points, such as the LIDAR points T. Each value of Euclidean distance in the first LIDAR dataset F1 may correspond to one of the distinct LIDAR points T.

$$dlcA = \sqrt{( {( l\_x - gpzA )}^{2} + {( l\_y - gpxA )}^{2}} \qquad ( 36 - 1 )$$

where,
dlcA=Euclidean distance between i^{th} LIDAR point and the target point A1
gpxA=x-coordinate of the target point A1 with respect to the reference point D
gpzA=z-coordinate of the target point A1 with respect to the reference point D

In one embodiment, the controller 110 may be configured determine an index of minimum value of dlcA in the first LIDAR dataset F1 as shown in Equation 36-2.

$$Idx Min A = min ( dlcA ) \qquad ( 36 - 2 )$$

where:
IdxMinA=index value of dlcA in the first LIDAR dataset F1

The LIDAR data (i.e., range and angle) corresponding to the (IdxMinA)^{th} index value may assist in determining the coordinates of the left leg of the bed 304. For example, the controller 110 may determine the coordinates of the left leg of bed 304 (BLL) based on Equation 36-3 and 36-4.

$$l\_xA = rangeA * Sin ( angle A ) \qquad ( 36 - 3 )$$

$$l\_yA = rangeA * Cos ( angle A ) \qquad ( 36 - 4 )$$

where:
l_xA=x-coordinate of BLL with respect to the LIDAR frame L
l_yA=y-coordinate of BLL with respect to the LIDAR frame L
rangeA=LIDAR range at (IdxMinA)^{th} index value in first LIDAR dataset F1
angleA=LIDAR's angle at (IdxMinA)^{th} index value in first LIDAR dataset F1

Similar to BLL, the controller 110 may be configured to determine a second LIDAR dataset F2 for determining coordinates of the right leg of bed 304 (BLR) with respect to the LIDAR frame L. The second LIDAR dataset F2 may include Euclidean distances between each of the LIDAR points T and the target point C1, as shown in Equation 37-1. The second LIDAR dataset F2 may include one or more values of Euclidean distances depending on the number of LIDAR points, such as the LIDAR points T. Each value of Euclidean distance in the second LIDAR dataset F2 may correspond to one of the distinct LIDAR points T.

$$dlcC = \sqrt{{( ( l\_x ) - gpzC )}^{2} + {( l\_y - gpxC )}^{2}} \qquad ( 37 - 1 )$$

where,
dlcC=Euclidean distance between i^{th} LIDAR point and the target point C1
gpxC=x-coordinate of the target point C1 with respect to the reference point D
gpzC=z-coordinate of the target point C1 with respect to the reference point D

In one embodiment, the controller 110 may be configured determine an index of minimum value of dlcC in the second LIDAR dataset F2 as shown in Equation 37-2.

$$IdxMinC = min ( dlcC )$$

where:
IdxMinC=index value of dlcC in the second LIDAR dataset F2

The LIDAR data (i.e., range and angle) corresponding to the (IdxMinC)^{th} index value may assist in determining the coordinates of BLR. For example, the controller 110 may determine the coordinates of BLR based on Equation 37-3 and 37-4.

$$l\_xC = rangeC * Sin ( angle C ) \qquad ( 37 - 3 )$$

$$l\_yC = rangeC * Cos ( angle C ) \qquad ( 37 - 4 )$$

where:
l_xC=x-coordinate of BLR with respect to the LIDAR frame L
l_yC=y-coordinate of BLR with respect to the LIDAR frame L
rangeC=LIDAR range at (IdxMinC)^{th} index value in second LIDAR dataset F2
angleC=LIDAR's angle at (IdxMinC)^{th} index value in second LIDAR dataset F2

Based on the coordinates of the second set of target points A1, C1 calculated with respect to the reference point D and with respect to the LIDAR frame L, as discussed above, the controller 110 may be configured to determine the coordinates of the third set of target points with respect to a world frame in the world coordinate system using Equation 38, where—
(z′_{A}, y′_{A}, x′_{A},)=coordinates of target point A2 with respect to world frame (or virtual map frame)
(z′_{C}, y′_{C}, x′_{C},)=coordinates of target point C2 with respect to world frame (or virtual map frame)
(z′_{M}, y′_{M}, x′_{M})=coordinates of target point M2 with respect to world frame (or virtual map frame)

$${}_{M}^{c} T = {}_{B . L}^{c} T * {}_{B . F}^{B . L} T * {}_{0}^{B . F} T * {}_{M}^{0} T \qquad ( 38 )$$

where,

$$\begin{matrix}{}_{M}^{c} T = camera 106 to virtual map transformation \\ {}_{B . L}^{c} T = camera 106 to base link ( of the mobile robot 100 ) transformation \\ {}_{B . F}^{B . L} T = base link to base footprint ( of the mobile robot 100 ) transformation \\ {}_{0}^{B . F} T = base footprint ( of the mobile robot 100 ) to odometry transformation \\ {}_{M}^{0} T = odometry to virtual map frame transformation\end{matrix}$$

In one embodiment, using Equation 38, the controller 110 may determine the coordinates of the target point A2 with respect to the world frame (or virtual map frame), as shown in Equation 39. Similarly, the controller 110 may use Equation 38 to determine the coordinates of the target point C2 with respect to the world frame (or virtual map frame), as shown in Equation 40. Further, the controller 110 may use Equation 38 to determine the coordinates of the target point M2 with respect to the world frame (or virtual map frame), as shown in Equation 41.

$$( \begin{matrix}{x}_{A}^{1} \\ {y}_{A}^{1} \\ {z}_{A}^{1} \\ 1\end{matrix} ) = ( {}_{M}^{C} T ) ( \begin{matrix}gpxA \\ yCA \\ gpzA \\ 1\end{matrix} ) \qquad ( 39 )$$

$$( \begin{matrix}{x}_{B}^{′} \\ {y}_{B}^{′} \\ {z}_{B}^{′} \\ 1\end{matrix} ) = ( {}_{M}^{C} T ) ( \begin{matrix}gpxc \\ yc \\ gpzc \\ 1\end{matrix} ) \qquad ( 40 )$$

$$( \begin{matrix}{x}_{M}^{′} \\ {y}_{M}^{′} \\ {z}_{M}^{′} \\ 1\end{matrix} ) = ( {}_{M}^{C} T ) ( \begin{matrix}gpxM \\ yC \\ gpzM \\ 1\end{matrix} ) \qquad ( 41 )$$

Hence, the controller 110 may determine a position of the mobile robot 100 relative to the target points A2, C2, M2 calculated using Equations 39-41 based on distances to these target points from the LIDAR frame L, where these distances may be calculated using Equations 36-37. Therefore, the controller 110 may localize the mobile robot 100 based on the calculated camera angles and the determined position of the mobile robot 100 relative to the third set of target points A2, C2, and M2. In one example, the target point A2 may include the target point A and/or A1, the target point C2 may include the target point C and/or C1, and the target point M2 may include the target point M and/or M1. Further, the third set of target points independently or in combination with the second set of target points may assist the controller 110 in autonomously navigating the mobile robot 100 without bumping into the target object such as the bed 304.

In some embodiments, the controller 110 may convert the ultrasonic signals from the ultrasonic sensors 202 into LIDAR data for purposes of calculating the coordinates of the target points from a pseudo-LIDAR frame. This conversion may assist the controller 110 in verifying a location of the object and distance to the object detected by the ultrasonic sensors 202. Moreover, the conversion may make ultrasonic data including information about the object from the ultrasonic sensors 202 compatible for use with the LIDAR data by the controller 110 for navigating the mobile robot 100. For example, multiple ultrasonic sensors such as the ultrasonic sensors 202 may be placed at different coordinates or positions on the mobile robot 100 with respect to the LIDAR frame L. The field of view (FOV) of the ultrasonic sensors 202 may be approximately 30 degrees, and an arc length of FOV of each of the ultrasonic sensors 202 with respect to an ultrasonic frame may be approximately equal to an arc length of FOV of laser scan data from the LIDAR sensor 204 for the same ultrasonic sensors 202 with respect to the LIDAR frame L. The controller 110 may be configured to convert the ultrasonic sensor data into laser scan data (or LIDAR data).

### Example

LaserScan msg type (e.g., LIDAR data):—

$$\begin{matrix}angle\_min = - 180 deg \\ angle\_max = 180 deg \\ angle increment = 0.5 deg \\ ranges = d\_ 1 , d\_ 2 , d\_ 3 , d\_ 4 , …………………………… , d\_ 717 , d\_ 718 , d\_ 719 , d\_ 720. \\ ranges size = 720\end{matrix}$$

TABLE 1

| | | | | | | | | | | | | | | |
|---|---|---|---|---|---|---|---|---|---|---|---|---|---|---|
| ranges | d_1 | d_2 | d_3 | d_4 | . . . | . . . | . . . | . . . | . . . | . . . | d_717 | d_718 | d_719 | d_720 |
| index | 1 | 2 | 3 | 4 | . . . | . . . | . . . | . . . | . . . | . . . | 717 | 718 | 719 | 720 |
| angle | −180 | −179.5 | −179 | −178.5 | . . . | . . . | . . . | . . . | . . . | . . . | 178.5 | 179 | 179.5 | 180 |
| (deg) | | | | | | | | | | | | | | |

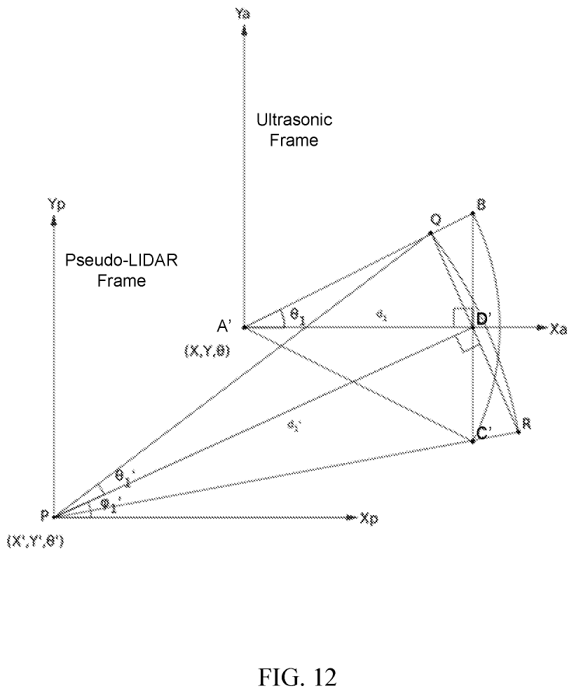

As illustrated in FIG. 12, the controller 110 may be configured to convert a single ultrasonic sensor data into LaserScan data (or LIDAR data). Similar conversion to laser scan data may be performed by the controller 110 for the remaining ultrasonic sensors 202 as well. For this, in one embodiment, the controller 110 may be configured to convert transform the ultrasonic frame to the pseudo-LIDAR frame, where.
Angle ZBA′D′=01=FOV of ultrasonic sensor/2
d₁ is range of ultrasonic sensor
A′(X,Y,θ)=Point A′ is coordinate of ultrasonic sensor with respect to pseudo LIDAR frame
P=(X′, Y′, θ′)=coordinate of a pseudo-LIDAR sensor presumed positioned at a location (or base link) of the LIDAR sensor 204
angle increment=0.5 deg

The controller 110 may be configured to determine θ′₁, coordinates of D′ (X′₁, Y′₁) w.r.t pseudo-LIDAR frame, d′₁, 1_rs, 1_re, and φ′. In one example, FIG. 12 illustrates (Xa, Ya) representing the ultrasonic frame and (Xp, Yp) representing the pseudo-LIDAR frame with the target object, such as the bed 304, located at, e.g., D′ (X′₁, Y′₁). In the ultrasonic frame (Xa, Ya), the controller 110 may determine:
∠BA′D′=∠D′A′C=half of FOV (e.g., 15 degrees) of the ultrasonic sensor at A′,
and BC is perpendicular to A′D′ which makes,
So, D′ may be the midpoint of BC

$$\begin{matrix}{A}^{′} B = {A}^{′} C \\ {BD}^{′} = {D}^{′} C\end{matrix}$$

where, coordinates of A′ are (X, Y, θ)

In pseudo-LIDAR frame (Xp, Yp), the controller 110 may determine that BC may be equal to QR and D′ may be the midpoint of QR. Further, the controller 110 may determine that QR may be perpendicular to PD which may make.

$$\begin{matrix}∴ ∠ {QPD}^{′} = ∠ {D}^{′} PR = {θ}_{1}^{′} \\ QP = PR \\ {QD}^{′} = {D}^{′} R \\ QR = BC \\ {QD}^{′} = {BD}^{′} \\ {D}^{′} C = {D}^{′} R \\ P = ( {X}^{′} , {Y}^{′} , {θ}^{′} )\end{matrix}$$

where ∠BAD′=θ₁ (where θ₁ is half of the FOV of ultrasonic sensor)

$${A}^{′} B = {d}_{1}$$

The controller 110 may determine

$$tan {θ}_{1} = \frac{BD ′}{A ′ D ′}$$

(which is perpendicular/Base) which may make BD′=d₁ tan θ₁—

$$∴ {BD}^{′} = {QD}^{′} \qquad ( 1 - 42 )$$

Now let's take

$$\begin{matrix}Δ {PD}^{′} Q \\ ∠ {QPD}^{′} = {θ}_{1}^{′}\end{matrix}$$

$$So$$

$$tan {θ}_{1} = \frac{QD ′}{{d}_{1}^{′}}$$

### Where

$${BD}^{′} = {QD}^{′} \qquad ( 2 - 43 )$$

which may make QD′=d′₁ tan θ′₁—

From equations (1-42) & (2-43)

$$\begin{matrix}{d}_{1} tan {θ}_{1} = {d}_{1}^{′} tan {θ}_{1}^{′} \\ {d}_{1}^{′} = \frac{{d}_{1} tan {θ}_{1}}{tan {θ}_{1}^{′}}\end{matrix} \qquad ( 3 - 44 )$$

$${θ}_{1}^{′} = {tan}^{- 1} ( \frac{{d}_{1} tan {θ}_{1}}{{d}_{1}^{′}} ) \qquad ( 4 - 45 )$$

In one example, the controller 110 may determine that P may be an origin of the pseudo-LIDAR frame which is P=(X′, Y′, θ′)=(0,0,0)

And in ultrasonic frame, the coordinate of D′ with respect to point A′. A′ may be the origin of the ultrasonic frame, where point D′ is (d₁, 0).

So, Coordinates of Point D′ with respect to ultrasonic frame is (d₁,0).

Also, Coordinates of Point A′ with respect to pseudo-LIDAR frame is (X,Y,θ) where P is the origin of the pseudo LIDAR frame.

The controller 110 may be further configured to determine the coordinate of D′ with respect to pseudo-LIDAR frame. Here, the controller 110 may use a Transformation matrix:

According to Generic Homogeneous Transformation Matrices
θ is rotation about z axis
dX is translation about X direction
dY is translation about Y direction
dZ is translation about Z direction

$$[ \begin{matrix}{X}^{′} \\ {Y}^{′} \\ {Z}^{′} \\ 1\end{matrix} ] = [ \begin{matrix}cos ( θ ) & - sin ( θ ) & 0 & dX \\ sin ( θ ) & cos ( θ ) & 0 & dY \\ 0 & 0 & 1 & dZ \\ 0 & 0 & 0 & 1\end{matrix} ] [ \begin{matrix}X \\ Y \\ Z \\ 1\end{matrix} ]$$

Thus, coordinate of

$$D ( {X}_{1}^{′} , {Y}_{1}^{′} )$$

w.r.t pseudo-LIDAR frame

$$[ \begin{matrix}{X}_{1}^{′} \\ {Y}_{1}^{′}\end{matrix} ] = [ \begin{matrix}cos ( θ ) & - sin ( θ ) & 0 & dX \\ sin ( θ ) & cos ( θ ) & 0 & dY\end{matrix} ] [ \begin{matrix}X \\ Y \\ Z \\ 1\end{matrix} ]$$

dX is the X Coordinate of the ultrasonic frame with respect to pseudo-LIDAR frame and
dY is the Y Coordinate of the ultrasonic frame with respect to pseudo-LIDAR frame.
where dX=X−X′ and dY=Y−Y′

$$\begin{matrix}{X}_{1}^{′} = X cos ( θ ) - y sin ( θ ) + dX \\ {Y}_{1}^{′} = Y sin ( θ ) + Y cos ( θ ) + dY\end{matrix}$$

Now the controller 110 may be configured to determine θ′₁

$$\begin{matrix}D ( {X}_{1}^{′} , {Y}_{1}^{′} ) \\ {d}_{1}^{′} = \sqrt{{( {X}_{t}^{′} - {X}^{′} )}^{2} + {( {Y}_{1}^{′} - {Y}^{′} )}^{2}} \\ {φ}^{′} = {tan}^{- 1} ( \frac{{Y}_{1}^{′}}{{X}_{1}^{′}} )\end{matrix}$$

From equation 4-45

$${θ}_{1}^{′} = {tan}^{- 1} ( \frac{{d}_{1} tan {θ}_{1}}{{d}_{1}^{′}} )$$

d₁=range of ultrasonic sensors 202

$${θ}_{1} = \frac{Fov of ultrasonic sensor}{2}$$

FOV of ultrasonic sensor w.r.t pseudo LIDAR frame=2*θ′₁

Further, the controller 110 may be configured to convert ultrasonic range data into laser scan data (or LIDAR data).
φ′=angle from x-axis of LIDAR frame
d₁′=range of laser scan data in FOV 2*θ′₁ w.r.t pseudo LIDAR frame
1_rs=LIDAR range data index start
1_re=LIDAR range data index end
laser scan data (or LIDAR data):—
angle_min
angle_max
angle_increment
ranges

Number LIDAR range data per degree=1/angle increment
1_rs=(φ′−θ′₁)*Number LIDAR range data per degree
1_re=(φ+θ′₁)*Number LIDAR range data per degree

### For Example No. 1

$$\begin{matrix}angle\_max = 180 deg \\ angle\_min = - 180 deg \\ angle increment = 0.5 deg \\ Number LIDAR range data per degree = 1 / angle increment = 1 / 0.5 = 2 \\ l\_rs = range size = \frac{max\_ang - min\_ang}{angle increment} = ( 180 - ( - 180 ) ) / 0.5 = 720 \\ range size = 720 \\ lidar range data = [ d\_ 1 , d\_ 2 , d\_ 3 , ………………………………… , d\_ 718 , d\_ 719 , d\_ 720 ]\end{matrix}$$

$$Let ' s l\_rs = 50 ; l\_re = 179$$

$$[ d\_ 50 , d\_ 51 , d\_ 52 , ………………………… , d\_ 177 , d\_ 178 , d\_ 179 ] = {d}_{1}^{′}$$

### Example No. 2

### Given

$$\begin{matrix}\cdot {d}_{1} = 1.2 m \\ \cdot {θ}_{1} = 15 deg \\ \cdot A ( X , Y , θ ) = A ( 2 , 3 , 45 ° ) \\ \cdot P ( {X}^{′} , {Y}^{′} , {θ}^{′} ) = P ( 0 , 0 , 0 ° ) \\ \cdot angle increment = 0.5 deg\end{matrix}$$

$$Find out$$

$$\begin{matrix}\cdot dX = X - {X}^{′} = 2 - 0 = 2 \\ \cdot dY = Y - {Y}^{′} = 3 - 0 = 3 \\ \cdot {X}_{1}^{′} = X cos ( θ ) - Y sin ( θ ) + dX = {2}^{*} cos ( 45 ) - {3}^{*} sin ( 45 ) + 2 = 1.2929 \\ \cdot {Y}_{1}^{′} = X sin ( θ ) + Y cos ( θ ) + dY = {2}^{*} sin ( 45 ) + {3}^{*} cos ( 45 ) + 3 = 6.5355 D ( {X}_{1}^{′} , {X}_{1}^{′} ) \\ \cdot {d}_{1}^{′} = \sqrt{{( {X}_{1}^{′} - X )}^{2} + {( {Y}_{1}^{′} \to {Y}^{′} )}^{2}} = \sqrt{{( 1.2929 - 0 )}^{2} + {( 6.5355 - 0 )}^{2}} = 9.24\end{matrix}$$

$$\begin{matrix}\cdot {φ}^{′} = {tan}^{- 1} ( \frac{{Y}_{1}^{′}}{{X}_{1}^{′}} ) = {tan}^{- 1} ( \frac{6.5355}{1.2929} ) = 78.8 deg \\ \cdot {θ}_{1}^{′} = {tan}^{- 1} ( \frac{{d}_{1} tan {θ}_{1}}{{d}_{1}^{′}} ) = {tan}^{- 1} ( \frac{1.2 * tan ( 15 )}{9.24} ) = 19.18 deg \\ \cdot Number LIDAR range data per degree = 1 / angle increment = 1 / 0.5 = 2 \\ {\cdot l\_rs = ( φ ’ - {θ}_{1}^{′} )}^{*} Number LIDAR range data per degree = {( 78.8 - 19.18 )}^{*} 2 = 119.24 = 119 \\ {\cdot l\_re = ( φ ’ + {θ}_{1}^{′} )}^{*} Number LIDAR range data per degree = {( 78.8 + 19.18 )}^{*} 2 = 195.96 = 195 \\ \cdot d\_ 119 , d\_ 120 , d\_ 121 , ………………………………………… , d\_ 193 , d\_ 194 , d\_ 195 = {d}_{1}^{′} = 9.24 m\end{matrix}$$

Similarly, values may be determined by the controller 110 for all other ultrasonic sensors 202.

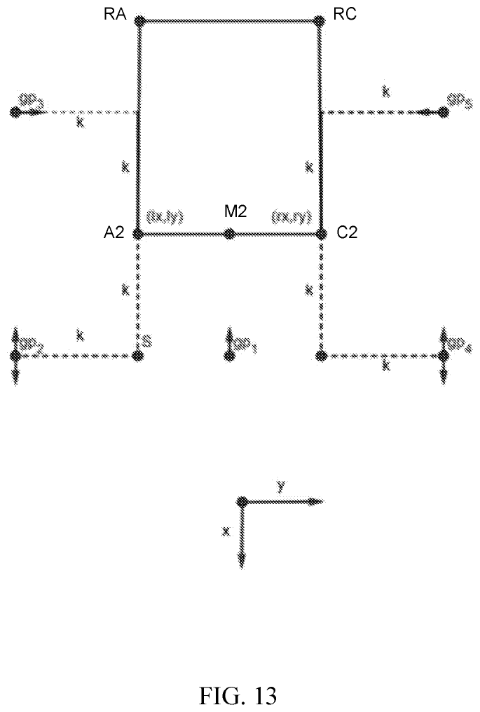

At step 6, goal points are determined for the mobile robot 100 with respect to the determined target points. As illustrated in FIG. 13, the controller 110 may be configured to determine goals points for autonomous navigation of the mobile robot 100 based on the previously determined coordinates of the target points A2, C2 with respect to the LIDAR frame. For example, the controller 110 may determine a slope of a line A2C2 in FIG. 13. The line A2C2 may pass through the target points A2, C2, and M2 of the bed 304. The slope of the line A2C2 may be calculated using Equation 46.

$$gth = {tan}^{- 1} ( \frac{( l γ + r γ )}{( lx + rx )} ) \qquad ( 46 )$$

Based on Equation 46, the controller 110 may calculate a slope of a line M2-gp1, which may be perpendicular to the line A2C2. The slope of the line M2-gp1 may be calculated by the controller 110 using Equation 47.

$$gth\_v = {tan}^{- 1} ( - \frac{( lx + rx )}{( l γ + r γ )} ) \qquad ( 47 )$$

The controller 110 may be configured to determine the goal point, gp1, based on Equations 46 and 47. The goal point gp1 may be calculated as shown in Equations 48-49.

$$gp 1 ( ( \frac{lx + rx}{2} ) - k * c o s ( gth\_v ) ; ( \frac{l γ + r γ}{2} ) - k * sin ( gth\_v ) ) \qquad ( 48 )$$

$$gp 1 ( ( \frac{lx + rx}{2} ) - k * cos ( gth\_v ) ; ( \frac{l γ + r γ}{2} ) - k * sin ( gth\_v ) ; 0.0 ; 0.0 ; 0.0 ; \frac{π}{2} - gth ) \qquad ( 49 )$$

where, k=minimum distance required to be maintained between the mobile robot 100 and the target points of the target object such as the bed 304

Similarly, the controller 110 may be configured to determine the goal point gp3 and gp5, or in some examples even goal point gp2 and gp4, provided there may be enough space available on the left side of the bed 304, i.e., the target object, for the mobile robot 100 to navigate therein. For example, in one embodiment, the controller 110 may create a cluster of data points of a first surface using the camera 106, as discussed above, where the first surface may be adjacent to a left lateral side of the bed 304. The controller 110 may calculate a mean of this cluster to determine a centroid V1 (not shown) in a similar manner as discussed above. Further, the controller 110 may calculate a Euclidean distance between the centroid V1 and the target point A2 of the bed 304, and compare the calculated Euclidean distance with a predefined threshold value. In one example, the threshold value may be predefined or dynamically defined by the controller 110 based on preset dimensions, such as a width, of the mobile robot 100. If the calculated Euclidean distance may be greater than the predefined threshold value, the controller 110 may continue to calculate the goal point gp3, and gp2, thereby indicating that there is sufficient space available on the left side of the bed 304 for the mobile robot 100 to navigate therein. Else, if the calculated Euclidean distance may be less than or equal to the predefined threshold value, the controller 110 may stop calculation of the goal point gp3. The controller 110 may calculate the goal point gp2 based on Equations 50-52 and calculate the goal point gp3 based on Equations 53-54.

$$gp 2 ( ( lx + K * cos ( gth ) - k * cos ( gth\_v ) ; ( ly + K * sin ( gth ) - k * sin ( gth\_v ) \qquad ( 50 )$$

$$\begin{matrix}gp 2 \_u ( ( lx + K * cos ( gth ) - k * cos ( gth\_v ) ; ( ly + K * sin ( gth ) - k * sin ( gth\_v ) ; \\ 0. ; 0. ; 0. ; \frac{π}{2} - gth )\end{matrix} \qquad ( 51 )$$

$$gp 2 \_d ( ( lx + K * cos ( gth ) - k * cos ( gth\_v ) ; ( ly + K * sin ( gth ) - k * sin ( gth\_v ) ; 0. ; 0. ; 0. ; \frac{π}{2} + gth ) \qquad ( 52 )$$

$$gp 3 ( ( lx + K * cos ( gth ) - k * cos ( gth\_v ) ; ( ly + K * sin ( gth ) - k * sin ( gth\_v ) \qquad ( 53 )$$

$$gp 3 ( ( lx + K * cos ( gth ) - k * cos ( gth\_v ) ; ( ly + K * sin ( gth ) - k * sin ( gth\_v ) ; 0. ; 0. ; 0. ; gth ) \qquad ( 54 )$$

Similarly, the controller 110 may create a cluster of data points of a second surface using the camera 106, as discussed above, where the second surface may be located adjacent to a right lateral side of the bed 304. The controller 110 may calculate a mean of this cluster to determine a centroid V2 (not shown) in a similar manner as discussed above. Further, the controller 110 may calculate a Euclidean distance between the centroid V2 and the target point C of the bed 304, and compare the calculated Euclidean distance with a predefined threshold value. If the calculated Euclidean distance may be greater than the predefined threshold value, the controller 110 may continue to calculate the goal point gp5, and gp4, thereby indicating that there is sufficient space available on the right side of the bed 304 for the mobile robot 100 to navigate therein. Else, if the calculated Euclidean distance may be less than or equal to the predefined threshold value, the controller 110 may stop calculation of the goal point gp5. The controller 110 may calculate the goal point gp2 based on Equations 55-57 and calculate the goal point gp3 based on Equations 58-59.

$$gp 4 ( ( rx + K * cos ( gth ) - k * cos ( gth\_v ) ; ( ry + K * sin ( gth ) - k * sin ( gth\_v ) \qquad ( 55 )$$

$$gp 4 \_u ( ( rx + K * cos ( gth ) - k * cos ( gth\_v ) ; ( ry + K * sin ( gth ) - k * sin ( gth\_v ) ; 0. ; 0. ; 0. ; gth ) ; 0. ; 0. ; 0. ; \frac{π}{2} - gth ) \qquad ( 56 )$$

$$gp 4 \_d ( ( rx + K * cos ( gth ) - k * cos ( gth\_v ) ; ( ry + K * sin ( gth ) - k * sin ( gth\_v ) ; 0. ; 0. ; 0. ; \frac{π}{2} + gth ) \qquad ( 57 )$$

$$gp 5 ( ( rx + K * cos ( gth ) - k * cos ( gth\_v ) ; ( ry + K * sin ( gth ) - k * sin ( gth\_v ) \qquad ( 58 )$$

$$gp 5 ( ( rx + K * cos ( gth ) - k * cos ( gth\_v ) ; ( ry + K * sin ( gth ) - k * sin ( gth\_v ) ; 0. ; 0. ; 0. ; - gth ) \qquad ( 59 )$$

At step 8, the controller 110 may autonomously navigate the mobile robot 100 to the determined goal points gp1, gp2, gp3, gp4, and gp5 to perform a preset task such as irradiating the bed 304, i.e., the target object, with UV light while maintaining a predefined minimum distance k between the mobile robot 100 and a portion of the bed 304 receiving the UV light.

The above description does not provide specific details of manufacture or design of the various components. Those of skill in the art are familiar with such details, and unless departures from those techniques are set out, techniques, known, related art or later developed designs and materials should be employed. Those in the art are capable of choosing suitable manufacturing and design details.

Note that throughout the present application, numerous references may be made regarding servers, services, engines, modules, interfaces, portals, platforms, or other systems formed from computing devices. It should be appreciated that the use of such terms is deemed to represent one or more computing devices having at least one processor (e.g., controller 110) configured to or programmed to execute software instructions stored on a computer readable tangible, non-transitory medium or also referred to as a processor-readable medium. For example, a server can include one or more computers operating as a web server, database server, or other type of computer server in a manner to fulfill described roles, responsibilities, or functions. Within the context of this document, the disclosed devices or systems are also deemed to comprise computing devices having a processor and a non-transitory memory storing instructions executable by the processor that cause the device to control, manage, or otherwise manipulate the features of the devices or systems.

Some portions of the detailed description herein are presented in terms of algorithms and symbolic representations of operations on data bits performed by conventional computer components, including a central processing unit (CPU), memory storage devices for the CPU, and connected display devices. These algorithmic descriptions and representations are the means used by those skilled in the data processing arts to most effectively convey the substance of their work to others skilled in the art. An algorithm is generally perceived as a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be understood, however, that all of these and similar terms are to be associated with the appropriate physical quantities and are merely convenient labels applied to these quantities. Unless specifically stated otherwise, as apparent from the discussion herein, it is appreciated that throughout the description, discussions utilizing terms such as “accessing” or “receiving” or “determining” or “identifying” or “accumulating” or “classifying” or “creating” or “comparing” or “storing” or “selecting” or “setting” or “sending” or “changing” or “updating” or “extracting” or “analyzing” or “localizing” the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The exemplary embodiment also relates to an apparatus for performing the operations discussed herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the methods/functions described herein. The structure for a variety of these systems is apparent from the description above. In addition, the exemplary embodiment is not described with reference to any particular programming language. It will be appreciated that a variety of programming languages may be used to implement the teachings of the exemplary embodiment as described herein.

The methods/functions illustrated throughout the specification, may be implemented in a computer program product that may be executed on a computer. The computer program product may comprise a non-transitory computer-readable recording medium on which a control program is recorded, such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

Alternatively, the methods may be implemented in transitory media, such as a transmittable carrier wave in which the control program is embodied as a data signal using transmission media, such as acoustic or light waves, such as those generated during radio wave and infrared data communications, and the like.

The terminology used herein is for the purpose of describing particular embodiments only and is not intended to be limiting of the disclosure. It will be appreciated that several of the above-disclosed and other features and functions, or alternatives thereof, may be combined into other systems or applications. Various presently unforeseen or unanticipated alternatives, modifications, variations, or improvements therein may subsequently be made by those skilled in the art without departing from the scope of the present disclosure as encompassed by the following claims.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. A computer-implemented method for a map-less localization of a robot, the computer-implemented method comprising:
receiving, using a controller, an image of an environment scanned by a camera located on a robot, wherein the environment includes a target object;
determining, using the controller, a first set of target points in a first coordinate system, the first set of target points representing the target object, wherein the first set of target points is determined with respect to a camera location on the robot;
defining, using the controller, a reference point in the image, the reference point being defined based on dimensions of the image, wherein the reference point is a center of the image;
determining, using the controller, a second set of target points representing the target object, the second set being determined in a second coordinate system and with respect to the reference point, wherein the second set of target points is determined at least based on the first set of target points and a camera distance from the camera location to the target object; and
localizing, using the controller, the robot with respect to the target object, wherein the robot is localized at least based on the second set of target points.

22. The computer-implemented method of claim 21, wherein the step of localizing further comprises:
determining, using the controller, a third set of target points representing the target object, the third set of target points being determined in the second coordinate system and with respect to a first location of a light detection and ranging (LIDAR) sensor on the robot, wherein the third set of target points is determined at least based on the second set of target points; and
initiating, using the controller, the robot to navigate or perform a predefined task relative to the target object, wherein the robot is initiated based on at least one of the second set of target points and the third set of target points.

23. The computer-implemented method of claim 22, further comprising:
receiving, using the controller, a sensor value from an ultrasonic sensor mounted at a second location on the robot, the sensor value being received based on the ultrasonic sensor scanning the environment, wherein the sensor value is a measure of distance to the target object with respect to the second location; and
determining, using the controller, a pseudo-LIDAR data in the second coordinate system, the pseudo-LIDAR data being determined at least based on the sensor value from the ultrasonic sensor, wherein the pseudo-LIDAR data is determined with respect to the first location of the LIDAR sensor on the robot.

24. The computer-implemented method of claim 23, wherein each of the at least two sets of target points selected from the first set of target points, the second set of target points, and the third set of target points includes a target point corresponding to the same feature of the target object.

25. The computer-implemented method of claim 21, wherein the step of receiving the image further comprises:
determining, using the controller, an object in the image and an object category related thereto based on stored object data including a group of objects and associated object categories;
receiving, using the controller, a target object category for performing a predefined task;
comparing, using the controller, the object category with the target object category; and
determining, using the controller, the target object based on the comparison, wherein the object is determined (i) as the target object if the object category matches the target object category and (ii) as an obstacle if the object category is either unavailable in the stored object data or different from the target object category.

26. The computer-implemented method of claim 25, wherein the target point represents an edge of the target object.

27. The computer-implemented method of claim 21, wherein the reference point is further defined by the controller based on a resolution of the camera.

28. The computer-implemented method of claim 21, further comprising:
determining, using the controller, one or more goal points relative to the target object, the one or more goal points being located around the target object, wherein the one or more goal points are determined at least based on the second set of target points; and
navigating, using the controller, the robot toward at least one of the one or more goal points.

29. The computer-implemented method of claim 28, wherein the one or more goal points are located at a preset distance from the corresponding nearest target point in the second set of target points, wherein the preset distance is greater than a set dimension of the robot.

30. The computer-implemented method of claim 28, wherein the one or more goal points include a first goal point and a second goal point, wherein the first goal point is proximate to a first edge of the target object and the second goal point is proximate to a second edge of the target object.

31. A system for a map-less localization of a robot, the system comprising:
a robot including a camera; and
a controller in communication with the robot, wherein the controller is configured to:
receive an image of an environment scanned by the camera located on the robot, wherein the environment includes a target object;
determine a first set of target points in a first coordinate system, the first set of target points representing the target object, wherein the first set of target points is determined with respect to a camera location on the robot;
define a reference point in the image, the reference point being defined based on dimensions of the image, wherein the reference point is a center of the image;
determine a second set of target points representing the target object, the second set being determined in a second coordinate system and with respect to the reference point, wherein the second set of target points is determined at least based on the first set of target points and a camera distance from the camera location to the target object; and
localize the robot with respect to the target object, wherein the robot is localized at least based on the second set of target points.

32. The system of claim 21, the controller is further configured to:
determine a third set of target points representing the target object, the third set of target points being determined in the second coordinate system and with respect to a first location of a light detection and ranging (LIDAR) sensor on the robot, wherein the third set of target points is determined at least based on the second set of target points; and
initiate the robot to navigate or perform a predefined task relative to the target object, wherein the robot is initiated based on at least one of the second set of target points and the third set of target points.

33. The system of claim 22, the controller is further configured to:
receive a sensor value from an ultrasonic sensor mounted at a second location on the robot, the sensor value being received based on the ultrasonic sensor scanning the environment, wherein the sensor value is a measure of distance to the target object with respect to the second location; and
determine a pseudo-LIDAR data in the second coordinate system, the pseudo-LIDAR data being determined at least based on the sensor value from the ultrasonic sensor, wherein the pseudo-LIDAR data is determined with respect to the first location of the LIDAR sensor on the robot.

34. The system of claim 33, wherein each of the at least two sets of target points selected from the first set of target points, the second set of target points, and the third set of target points includes a target point corresponding to the same feature of the target object.

35. The system of claim 31, wherein the controller is further configured to:
determine an object in the image and an object category related thereto based on stored object data including a group of objects and associated object categories;
receive a target object category for performing a predefined task;
compare the object category with the target object category; and
determine the target object based on the comparison, wherein the object is determined (i) as the target object if the object category matches the target object category and (ii) as an obstacle if the object category is either unavailable in the stored object data or different from the target object category.

36. The system of claim 35, wherein the target point represents an edge of the target object.

37. The system of claim 31, wherein the controller is further configured to define the reference point based on a resolution of the camera.

38. The system of claim 31, the controller is further configured to:
determine one or more goal points relative to the target object, the one or more goal points being located around the target object, wherein the one or more goal points are determined at least based on the second set of target points; and
navigate the robot toward at least one of the one or more goal points.

39. The system of claim 38, wherein the one or more goal points are located at a preset distance from the corresponding nearest target point in the second set of target points, wherein the preset distance is greater than a set dimension of the robot.

40. The system of claim 38, wherein the one or more goal points include a first goal point and a second goal point, wherein the first goal point is proximate to a first edge of the target object and the second goal point is proximate to a second edge of the target object.
